(19) United States
(12) Patent Application Publication
(10) Pub. No.: US 2026/0352127 A1
(43) Pub. Date: Nov. 5, 2026

(54) ELECTRIC WORK MACHINE AND CONTROL METHOD

(71) Applicant: MAKITA CORPORATION, Anjo-shi (JP)

(72) Inventors: Shin TSUJITA, Anjo-shi (JP); Shu ISAKA, Anjo-shi (JP); Yuya MATSUYAMA, Anjo-shi (JP); Yuki MATSUMOTO, Anjo-shi (JP); Kenta TOMINAGA, Anjo-shi (JP); Takeru FUNAHASHI, Anjo-shi (JP); Kouichi TAKEDA, Anjo-shi (JP)

(73) Assignee: MAKITA CORPORATION, Anjo-shi (JP)

(21) Appl. No.: 19/648,463

(22) Filed: Apr. 15, 2026

(30) Foreign Application Priority Data
Apr. 30, 2025 (JP) 2025-075594
Mar. 5, 2026 (JP) 2026-035475

(51) Int. Cl. H02P 21/22; B25F 5/00; B27B 17/02; B27B 17/08; H02P 21/00; H02P 21/18

(52) U.S. Cl. CPC H02P 21/22; B25F 5/00; H02P 21/0089; H02P 21/18; B27B 17/02; B27B 17/08; H02P 2207/05

(57) ABSTRACT

An electric work machine includes a motor including a stator and a rotor, and a control circuit. The control circuit is configured to control the motor to cause a current corresponding to a current command value to flow through the stator. In a d-q coordinate system having d-axis and q-axis orthogonal to each other, the control circuit is configured to set the current command value in a region on a positive side of the q-axis relative to both a given constant torque curve and a maximum flux efficiency curve in association with a measured value of a q-axis component of the current being included in a region on a positive side of the q-axis relative to an intersection of the given constant torque curve and the maximum flux efficiency curve.

### CROSS-REFERENCE TO RELATED APPLICATIONS

This application claims the benefit of Japanese Patent Application No. 2025-075594 filed on Apr. 30, 2025 with the Japan Patent Office, and Japanese Patent Application No. 2026-035475 filed on Mar. 5, 2026 with the Japan Patent Office, and the entire disclosures of which are incorporated herein by reference.

### BACKGROUND

The present disclosure relates to an electric work machine.

As a control method for a brushless DC motor, field-oriented control (FOC) is known in which a current vector is controlled so as to effectively generate torque in consideration of the orientation, rotational speed, and the like of a rotor. For example, Japanese Patent No. 7257647 discloses an electric work machine that combines the field-oriented control with field-weakening control.

The field-weakening control is a technique for achieving high-speed rotations by reducing back electromotive force by partially reducing magnetic flux of permanent magnets of a rotor when the maximum rotational frequency decreases due to the back electromotive force becoming equivalent to power supply voltage in a high-speed rotation region of a motor.

### SUMMARY

When switching from the field-weakening control to the normal field-oriented control, output of a motor based on its rotational speed and torque may become unstable due to a rapid change in a current vector.

Preferably, one aspect of the present disclosure can provide a technique to stabilize the output of the motor in the field-oriented control of the motor.

One aspect of the present disclosure is an electric work machine including a motor and a control circuit. The motor includes a stator and a rotor and is configured to be driven by receiving electric power from a power supply. The stator is configured to generate a magnetic field by a current flowing therethrough. The rotor includes a magnetic material and is configured to rotate about a rotational axis in response to a change in the magnetic field. The current includes a d-axis component, which is a component of a direct-axis (hereinafter referred to as d-axis), and a q-axis component, which is a component of a quadrature-axis (hereinafter referred to as q-axis), in a d-q coordinate system having the d-axis and the q-axis orthogonal to each other. The control circuit is configured to control the motor so as to cause the current corresponding to a current command value to flow through the stator. In association with a measured value of the q-axis component being included in a region on a positive side of the q-axis relative to an intersection of a given constant torque curve and a maximum flux efficiency curve, the control circuit is configured to set the current command value in a region on a positive side of the q-axis relative to both the constant torque curve and the maximum flux efficiency curve. The maximum flux efficiency curve is a set of points where maximum torque per unit magnetic flux is obtained in the d-q coordinate system.

According to such a configuration, when switching from the field-weakening control to the normal field-oriented control, the current command value is set in a direction that does not decrease torque. Therefore, the output of the motor can be stabilized.

In one aspect of the present disclosure, in association with the measured value of the q-axis component being included in the region on the positive side of the q-axis relative to the intersection of the given constant torque curve and the maximum flux efficiency curve, the control circuit may be configured to set the current command value in the region on the positive side of the q-axis relative to both the given constant torque curve and the maximum flux efficiency curve and in a region on a negative side of the q-axis relative to a maximum current efficiency curve. The maximum current efficiency curve may be a set of points where maximum torque per unit current is obtained in the d-q coordinate system.

According to such a configuration, the current command value is set so as not to exceed the maximum current efficiency curve. Therefore, a decrease in output efficiency of the motor can be inhibited.

One aspect of the present disclosure is an electric work machine including a motor and a control circuit. The motor includes a stator and a rotor and is configured to be driven by receiving electric power from a power supply. The stator is configured to generate a magnetic field by a current flowing therethrough. The rotor includes a magnetic material and is configured to rotate about a rotational axis in response to a change in the magnetic field. The control circuit is configured to transition between two or more modes including a first mode, a second mode, and a third mode, to operate in one of the modes, and to control the motor so as to cause the current corresponding to the current command value to flow through the stator. In the first mode, the control circuit is configured to set the current command value so as to maximize torque per unit current. In the second mode, the control circuit is configured to set the current command value so as to generate the magnetic field in a direction that reduces magnetic flux generated from the magnetic material. In association with transitioning from the second mode to the first mode, the control circuit is configured to operate so as to pass through the third mode.

In association with the control circuit transitions from the second mode to the third mode, the control circuit is configured to store a measured value of the current that was flowing through the stator and the current command value to be flowed through the stator as a reference measured value and a reference command value, respectively. The control circuit is configured to set the current command value in the third mode based on at least one of the reference measured value or the reference command value.

According to such a configuration, in the third mode that is passed through when switching from the second mode corresponding to the field-weakening control to the first mode corresponding to the normal field-oriented control, the current command value is set based on the reference measured value and the reference command value. Therefore, a rapid change in the current vector can be inhibited. Thus, the output of the motor can be stabilized.

In one aspect of the present disclosure, the control circuit may be configured to set the current command value in the third mode based on both a difference between the reference measured value and the measured value of the current, and the reference command value.

According to such a configuration, when switching from the second mode corresponding to the field-weakening control to the first mode corresponding to the normal field-oriented control, the current command value is set based on the reference command value and further based on a difference between the reference measured value and a measured value of the current. Therefore, the output of the motor can be stabilized.

In one aspect of the present disclosure, in the d-q coordinate system having the d-axis and the q-axis orthogonal to each other, the current may include the d-axis component that is a component of the d-axis and the q-axis component that is a component of the q-axis. The control circuit may be configured to transition from the second mode to the third mode in response to the measured value of the q-axis component being greater than or equal to a given threshold value.

According to such a configuration, the operation mode can be switched based on the measured value of the q-axis component. Therefore, the motor can be controlled in an optimal operation mode corresponding to the measured value of the q-axis component.

In one aspect of the present disclosure, the control circuit may be configured to set the current command value in the third mode in a region on a positive side of the q-axis relative to the constant torque curve in the d-q coordinate system.

According to such a configuration, when switching from the second mode corresponding to the field-weakening control to the first mode corresponding to the normal field-oriented control, the current command value is set in a direction that does not decrease torque. Therefore, the output of the motor can be stabilized.

In one aspect of the present disclosure, the control circuit may be configured to transition between two or more modes based on the measured value of the q-axis component.

According to such a configuration, the motor can be controlled in an optimal operation mode corresponding to the measured value of the q-axis component.

In one aspect of the present disclosure, the control circuit may perform constant rotation control, based on the d-axis component in the current command value, for maintaining the rotational frequency of the motor constant.

According to such a configuration, the constant rotation control can be achieved by setting an appropriate current vector based on both the q-axis component and the d-axis component in the current command value.

In one aspect of the present disclosure, the constant rotation control may include a process of decreasing the d-axis component in the current command value.

In one aspect of the present disclosure, the constant rotation control may include a process of decreasing the d-axis component in the current command value such that the command value of the current is set within a region of a back-EMF limit ellipse in the d-q coordinate system.

According to such a configuration, in the constant rotation control, a decrease in the q-axis component in the current command value can be inhibited. Therefore, in the constant rotation control, a decrease in torque can be inhibited.

In one aspect of the present disclosure, the control circuit may be configured to obtain a measured value of a power supply current supplied from the power supply and an upper limit value of the power supply current. The control circuit may be configured to calculate an upper limit value of the d-axis component of the current command value based on the measured value of the power supply current and the upper limit value of the power supply current.

In one aspect of the present disclosure, the control circuit may be configured to calculate the upper limit value of the d-axis component of the current command value by multiplying a measured value of the d-axis component by a value obtained by adding 1 (one) to a difference between the measured value of the power supply current and the upper limit value of the power supply current.

According to such a configuration, the upper limit value of the d-axis component of the current command value can be dynamically calculated based on the measured value of the power supply current so as not to exceed the upper limit value of the power supply current.

One aspect of the present disclosure is an electric work machine including a motor and a control circuit. The motor includes a stator and a rotor and is configured to be driven by receiving electric power from a power supply. The stator is configured to generate a magnetic field by a current flowing therethrough. The rotor includes a magnetic material and is configured to rotate about a rotational axis in response to a change in the magnetic field. The control circuit is configured to transition between two or more modes including a first mode, a second mode, and a third mode, to operate in one of the modes, and to control the motor so as to cause the current corresponding to a current command value to flow through the stator. In the first mode, the control circuit is configured to set the current command value so as to maximize torque per unit current. In the second mode, the control circuit is configured to set the current command value so as to generate the magnetic field in a direction that reduces magnetic flux generated from the magnetic material. In association with transitioning from the second mode to the first mode, the control circuit is configured to operate so as to pass through the third mode. In the third mode, the control circuit is configured to set the current command value such that torque of the motor increases as rotational frequency of the motor decreases.

According to such a configuration, when switching from the second mode corresponding to the field-weakening control to the first mode corresponding to the normal field-oriented control, a rapid decrease in the output of the motor can be inhibited. Therefore, the output of the motor can be stabilized.

One aspect of the present disclosure is a control method for controlling a motor including a stator and a rotor. The method including controlling the motor so as to cause a current corresponding to a current command value to flow through the stator; and setting a current command value in a region on a positive side of the q-axis relative to both a constant torque curve and a maximum flux efficiency curve in a d-q coordinate system having a d-axis and a q-axis orthogonal to each other in association with the measured value of the q-axis component, which is a component of the q-axis of the current, being included in a region on a positive side of the q-axis relative to an intersection of a given constant torque curve and the maximum flux efficiency curve. The maximum flux efficiency curve is a set of points where maximum torque per unit magnetic flux is obtained in the d-q coordinate system.

According to this control method, effects similar to those of the electric work machine described above are achieved.

One aspect of the present disclosure is a control method for controlling a motor including a stator and a rotor, the method including controlling the motor so as to cause a current corresponding to a current command value to flow through the stator; transitioning between two or more modes including a first mode, a second mode, and a third mode, operating in one mode of the modes, and controlling the motor so as to cause the current corresponding to the current command value to flow through the stator; setting the current command value so as to maximize torque per unit current in the first mode; setting the current command value so as to generate a magnetic field in a direction that reduces magnetic flux generated from a magnetic material of the rotor in the second mode; operating so as to pass through the third mode in association with transitioning from the second mode to the first mode; and setting the current command value in a region on a positive side of a q-axis relative to a constant torque curve in a d-q coordinate system in the third mode.

According to this control method, effects similar to those of the electric work machine described above are achieved.

### BRIEF DESCRIPTION OF THE DRAWINGS

Example embodiments of the present disclosure will be described hereinafter with reference to the accompanying drawings, in which:

FIG. 1 is a perspective view of an electric work machine;

FIG. 2 is a diagram explaining an electrical configuration of the electric work machine;

FIG. 3 is a diagram explaining an electrical configuration of a control circuit;

FIG. 4 is a diagram explaining a process of a limit value calculation unit;

FIG. 5 is a flowchart showing an interruption process executed by the control circuit;

FIG. 6 is a state-transition diagram showing operation modes of the control circuit;

FIG. 7 is a flowchart showing a field-weakening control process;

FIG. 8 is a flowchart showing an MTPA process;

FIG. 9 is a flowchart showing a field-weakening process;

FIG. 10 is a flowchart showing a transition in-progress process;

FIG. 11 is a flowchart showing a regeneration process;

FIG. 12 is a diagram explaining current trajectories in a d-q coordinate system;

FIG. 13 is a diagram explaining N-T characteristics;

FIG. 14 is a diagram explaining T-N characteristics and I-N characteristics;

FIG. 15 is a diagram explaining mechanical configurations of a motor, a drive transmission, and a saw chain of an electric work machine in a second embodiment;

FIG. 16 is a diagram explaining a diameter of the motor and a stack length of a stator of the electric work machine in the second embodiment;

FIG. 17 is a diagram explaining actual N-T characteristics, actual P-T characteristics, actual I-T characteristics, and actual V-T characteristics when control in the first embodiment is performed on the motor, having a maximum output of about 2 to 3 [kW], of the electric work machine in the second embodiment;

FIG. 18 is a diagram explaining the actual N-T characteristics, the actual P-T characteristics, the actual I-T characteristics, and the actual V-T characteristics when the control in the first embodiment is performed on the motor, having a maximum output of about 3 to 4 [kW], of the electric work machine in the second embodiment;

FIG. 19 is a perspective view of an electric work machine in a third embodiment when viewed from a side where a blade is attached (blade side);

FIG. 20 is a perspective view of the electric work machine in the third embodiment when viewed from a side where a housing is situated (housing side);

FIG. 21 is a perspective view of the electric work machine in the third embodiment when the housing and a motor are removed;

FIG. 22 is a cross-sectional view of the electric work machine in the third embodiment including a cooling fan and taken perpendicular to left-right directions;

FIG. 23 is a cross-sectional view of the electric work machine in the third embodiment including the motor and a drive transmission and taken perpendicular to front-rear directions;

FIG. 24 is a diagram explaining actual N-T characteristics, actual P-T characteristics, actual I-T characteristics, and actual V-T characteristics of the motor when control in the third embodiment is performed on the motor;

FIG. 25 is a diagram explaining the actual N-T characteristics, the actual P-T characteristics, the actual I-T characteristics, and the actual V-T characteristics on a side where a blade driven by the motor is attached (blade side) when the control in the third embodiment is performed on the motor;

FIG. 26 is a diagram explaining current trajectories in the d-q coordinate system when a slope is positive in another embodiment;

FIG. 27 is a diagram explaining current trajectories in the d-q coordinate system when the slope is negative in another embodiment; and

FIG. 28 is a diagram explaining the current trajectories in the d-q coordinate system when directly transitioning from a back-EMF limit ellipse to an MTPA curve in another embodiment.

### DETAILED DESCRIPTION OF EXEMPLARY EMBODIMENTS

### 1. Overview of Embodiments

An embodiment may provide an electric work machine. The electric work machine may include at least one of the following features. In the present disclosure, “command value” may also be referred to as “reference value” or “commanded value,” “reference measured value” may also be referred to as “base measured value,” and “reference command value” may also be referred to as “base command value,” “base reference value,” or “base commanded value.”
Feature 1: an electric work machine includes a motor.
Feature 2: the motor includes a stator.
Feature 3: the motor includes a rotor.
Feature 4: the motor is configured to be driven by receiving electric power from a power supply.
Feature 5: the electric work machine includes a control circuit.
Feature 6: the stator is configured to generate a magnetic field by a current flowing therethrough.
Feature 7: the rotor includes a magnetic material.
Feature 8: the rotor is configured to rotate about a rotational axis.
Feature 9: the rotor is configured to rotate in response to a change in the magnetic field.
Feature 10: the current includes a d-axis component, which is a component of a d-axis, and a q-axis component, which is a component of a q-axis, in a d-q coordinate system having the d-axis and the q-axis orthogonal to each other.
Feature 11: the control circuit is configured to control the motor.
Feature 12: the control circuit is configured to cause the current corresponding to a current command value to flow through the stator.
Feature 13: the control circuit is configured to control the motor so as to cause the current corresponding to the current command value to flow through the stator.
Feature 14: the control circuit is configured to set the current command value in a region on a positive side of the q-axis relative to a constant torque curve in association with a measured value of the q-axis component being included in a region on a positive side of the q-axis relative to an intersection of a given constant torque curve and a maximum flux efficiency curve.
Feature 15: the control circuit is configured to set the current command value in a region on a positive side of the q-axis relative to the maximum flux efficiency curve in association with the measured value of the q-axis component being included in the region on the positive side of the q-axis relative to the intersection of the given constant torque curve and the maximum flux efficiency curve.
Feature 16: the control circuit is configured to set the current command value in a region on a positive side of the q-axis relative to both the constant torque curve and the maximum flux efficiency curve in association with the measured value of the q-axis component being included in the region on the positive side of the q-axis relative to the intersection of the given constant torque curve and the maximum flux efficiency curve.
Feature 17: the maximum flux efficiency curve is a set of points where maximum torque per unit magnetic flux is obtained in the d-q coordinate system.

According to the electric work machine having at least Features 1 to 17, the current command value is set in a direction that does not decrease torque when switching from field-weakening control to normal field-oriented control. Therefore, the output of the motor can be stabilized.

One embodiment may include at least one of the following features in addition to or in place of at least one of Features 1 to 17.
Feature 18: the control circuit is configured to set the current command value in a region on a negative side of the q-axis relative to a maximum current efficiency curve in association with the measured value of the q-axis component being included in the region on the positive side of the q-axis relative to the intersection.
Feature 19: the control circuit is configured to set the current command value in the region on the positive side of the q-axis relative to the constant torque curve and in the region on the negative side of the q-axis relative to the maximum current efficiency curve in association with the measured value of the q-axis component being included in the region on the positive side of the q-axis relative to the intersection.
Feature 20: the control circuit is configured to set the current command value in the region on the positive side of the q-axis relative to the maximum flux efficiency curve and in the region on the negative side of the q-axis relative to the maximum current efficiency curve in association with the measured value of the q-axis component being included in the region on the positive side of the q-axis relative to the intersection.
Feature 21: the control circuit is configured to set the current command value in the region on the positive side of the q-axis relative to both the constant torque curve and the maximum flux efficiency curve and in the region on the negative side of the q-axis relative to the maximum current efficiency curve in association with the measured value of the q-axis component being included in the region on the positive side of the q-axis relative to the intersection.
Feature 22: the maximum current efficiency curve is a set of points where maximum torque per unit current is obtained in the d-q coordinate system.

According to the electric work machine having at least Features 1 to 22, the current command value is set so as not to exceed the maximum current efficiency curve. Therefore, a decrease in output efficiency of the motor can be inhibited.

An embodiment may include at least one of the following features in addition to or in place of at least one of Features 1 to 22.
Feature 23: the control circuit is configured to transition between two or more modes.
Feature 24: the control circuit is configured to transition between two or more modes including a first mode, a second mode, and a third mode.
Feature 25: the control circuit is configured to operate in one mode of the modes.
Feature 26: the control circuit is configured to transition between two or more modes including the first mode, the second mode, and the third mode, and to operate in one mode of the modes.
Feature 27: the control circuit is configured to set the current command value so as to maximize the torque per unit current.
Feature 28: in the first mode, the control circuit is configured to set the current command value so as to maximize the torque per unit current.
Feature 29: the control circuit is configured to set the current command value so as to generate a magnetic field in a direction that reduces magnetic flux generated from the magnetic material.
Feature 30: in the second mode, the control circuit is configured to set the current command value so as to generate a magnetic field in the direction that reduces magnetic flux generated from the magnetic material.
Feature 31: the control circuit is configured to pass through the third mode in association with transitioning from the second mode to the first mode.
Feature 32: the control circuit is configured to store a measured value of the current that was flowing through the stator as a reference measured value.
Feature 33: the control circuit is configured to store a measured value of the current that was flowing through the stator as a reference measured value in association with transitioning from the second mode to the third mode.
Feature 34: the control circuit is configured to store a current command value to be flowed through the stator as a reference command value.
Feature 35: the control circuit is configured to store the current command value to be flowed through the stator as the reference command value in association with transitioning from the second mode to the third mode.
Feature 36: the control circuit is configured to store the measured value of the current that was flowing through the stator and the current command value to be flowed through the stator as the reference measured value and the reference command value, respectively, in association with transitioning from the second mode to the third mode.
Feature 37: the control circuit is configured to set the current command value in the third mode based on at least one of the reference measured value and the reference command value.

According to the electric work machine having at least Features 1 to 37, in the third mode that is passed through when switching from the second mode corresponding to the field-weakening control to the first mode corresponding to the normal field-oriented control, the current command value is set based on the reference measured value and the reference command value. Therefore, a rapid change in the current vector can be inhibited. Thus, the output of the motor can be stabilized.

An embodiment may include at least one of the following features in addition to or in place of at least one of Features 1 to 37.
Feature 38: the control circuit is configured to set the current command value in the third mode based on a difference between the reference measured value and the measured value of the current.
Feature 39: the control circuit is configured to set the current command value in the third mode based on the reference command value.
Feature 40: the control circuit is configured to set the current command value in the third mode based on both the difference between the reference measured value and the measured value of the current, and the reference command value.

According to the electric work machine having at least Features 1 to 40, when switching from the second mode corresponding to the field-weakening control to the first mode corresponding to the normal field-oriented control, the current command value is set based on the difference between the reference measured value and the measured value of the current in addition to the reference command value. Therefore, the output of the motor can be stabilized.

An embodiment may include at least one of the following features in addition to or in place of at least one of Features 1 to 40.
Feature 41: the control circuit is configured to transition from the second mode to the third mode.
Feature 42: the control circuit is configured to transition from the second mode to the third mode in association with the measured value of the q-axis component being greater than or equal to a given threshold value.

According to the electric work machine having at least Features 1 to 42, an operation mode can be switched based on the measured value of the q-axis component. Therefore, the motor can be controlled in an optimal operation mode corresponding to the measured value of the q-axis component.

An embodiment may include at least one of the following features in addition to or in place of at least one of Features 1 to 42.
Feature 43: the control circuit is configured to set the current command value in a region on a positive side of the q-axis relative to the constant torque curve in the d-q coordinate system.
Feature 44: in the third mode, the control circuit is configured to set the current command value in the region on the positive side of the q-axis relative to the constant torque curve in the d-q coordinate system.

According to the electric work machine having at least Features 1 to 44, when switching from the second mode corresponding to the field-weakening control to the first mode corresponding to the normal field-oriented control, the current command value is set in a direction that does not decrease torque. Therefore, the output of the motor can be stabilized.

An embodiment may include the following feature in addition to or in place of at least one of Features 1 to 44.
Feature 45: the control circuit is configured to transition between two or more modes based on the measured value of the q-axis component.

According to the electric work machine having at least Features 1 to 45, the motor can be controlled in an optimal operation mode corresponding to the measured value of the q-axis component.

An embodiment may include at least one of the following features in addition to or in place of at least one of Features 1 to 45.
Feature 46: the control circuit is configured to perform constant rotation control for maintaining the rotational frequency of the motor constant.
Feature 47: the control circuit is configured to perform the constant rotation control, based on the d-axis component in the current command value, for maintaining the rotational frequency of the motor constant.

According to the electric work machine having at least Features 1 to 47, the constant rotation control can be achieved by setting an appropriate current vector based on both the q-axis component and the d-axis component in the current command value.

An embodiment may include at least one of the following features in addition to or in place of at least one of Features 1 to 47.
Feature 48: the constant rotation control includes a process of decreasing the d-axis component in the current command value.
Feature 49: the constant rotation control includes a process of decreasing the d-axis component in the current command value such that the command value of the current is set within a region of a back-EMF limit ellipse in the d-q coordinate system.

According to the electric work machine having at least Features 1 to 49, in the constant rotation control, a decrease in the q-axis component in the current command value can be inhibited. Therefore, in the constant rotation control, a decrease in torque can be inhibited.

An embodiment may include at least one of the following features in addition to or in place of at least one of Features 1 to 49.
Feature 50: the control circuit is configured to obtain a measured value of a power supply current supplied from the power supply.
Feature 51: the control circuit is configured to obtain an upper limit value of the power supply current.
Feature 52: the control circuit is configured to obtain the measured value of the power supply current supplied from the power supply and the upper limit value of the power supply current.
Feature 53: The control circuit is configured to calculate an upper limit value of the d-axis component of the current command value.
Feature 54: the control circuit is configured to calculate the upper limit value of the d-axis component of the current command value based on the measured value of the power supply current.
Feature 55: the control circuit is configured to calculate the upper limit value of the d-axis component of the current command value based on the upper limit value of the power supply current.
Feature 56: the control circuit is configured to calculate the upper limit value of the d-axis component of the current command value based on the measured value of the power supply current and the upper limit value of the power supply current.
Feature 57: the control circuit is configured to calculate the upper limit value of the d-axis component of the current command value by multiplying the d-axis component of the current command value by a value obtained by adding 1 (one) to a difference between the measured value of the power supply current and the upper limit value of the power supply current.

According to the electric work machine having at least Features 1 to 57, the upper limit value of the d-axis component of the current command value can be dynamically calculated based on the measured value of the power supply current so as not to exceed the upper limit value of the power supply current.

An embodiment may include the following feature in addition to or in place of at least one of Features 1 to 57.
Feature 58: in the third mode, the control circuit is configured to set the current command value such that the torque of the motor increases as the rotational frequency of the motor decreases.

According to the electric work machine having at least Features 1 to 58, when switching from the second mode corresponding to the field-weakening control to the first mode corresponding to the normal field-oriented control, a rapid decrease in the output of the motor can be inhibited. Therefore, the output of the motor can be stabilized.

Examples of the electric work machine include various electric machines used in a work site such as home carpentry, manufacturing, gardening, and construction and configured to be driven by a battery; specifically, electric power tools for stone processing, metal processing, or wood processing, work machines for gardening, and a device for improving a work site environment; more specifically, an electric blower, an electric hammer, an electric hammer drill, an electric drill, an electric screwdriver, an electric wrench, an electric grinder, an electric circular saw, an electric reciprocating saw, an electric jigsaw, an electric cutter, an electric chainsaw, an electric planer, an electric nailer (including a tacker), an electric hedge trimmer, an electric lawn mower, an electric lawn trimmer, an electric grass cutter, an electric cleaner, an electric sprayer, an electric spreader, an electric dust collector, a robotic cleaner, a battery-powered wheel barrow, a battery-powered bicycle, fan-equipped vest, and a heated jacket.

In an embodiment, Features 1 to 58 may be combined in any manner.

In an embodiment, at least one of Features 1 to 58 may be excluded. An embodiment may provide a control method. The control method may include at least one of the following features.
Feature 59: controlling a motor.
Feature 60: the motor includes a stator.
Feature 61: the motor includes a rotor.
Feature 62: the motor includes the stator and the rotor.
Feature 63: controlling a motor.
Feature 64: causing current corresponding to a current command value to flow through the stator.
Feature 65: controlling the motor so as to cause current corresponding to the current command value to flow through the stator.
Feature 66: in a d-q coordinate system having a d-axis and a q-axis orthogonal to each other, setting the current command value in a region on a positive side of the q-axis relative to a constant torque curve.
Feature 67: in the d-q coordinate system having the d-axis and the q-axis orthogonal to each other, setting the current command value in a region on a positive side of the q-axis relative to a maximum flux efficiency curve.
Feature 68: in the d-q coordinate system having the d-axis and the q-axis orthogonal to each other, setting the current command value in a region on a positive side of the q-axis relative to at least one of the constant torque curve and the maximum flux efficiency curve.
Feature 69: in the d-q coordinate system having the d-axis and the q-axis orthogonal to each other, setting the current command value in a region on a positive side of the q-axis relative to both the constant torque curve and the maximum flux efficiency curve.
Feature 70: in the d-q coordinate system having the d-axis and the q-axis orthogonal to each other, in association with a measured value of a q-axis component, which is a component of the q-axis of the current, being included in a region on a positive side of the q-axis relative to an intersection of a given constant torque curve and the maximum flux efficiency curve, setting the current command value in a region on a positive side of the q-axis relative to the constant torque curve.
Feature 71: in the d-q coordinate system having the d-axis and the q-axis orthogonal to each other, in association with the measured value of the q-axis component, which is a component of the q-axis of the current, being included in the region on the positive side of the q-axis relative to the intersection of the given constant torque curve and the maximum flux efficiency curve, setting the current command value in a region on a positive side of the q-axis relative to the maximum flux efficiency curve.
Feature 72: in the d-q coordinate system having the d-axis and the q-axis orthogonal to each other, in association with the measured value of the q-axis component, which is a component of the q-axis of the current, being included in the region on the positive side of the q-axis relative to the intersection of the given constant torque curve and the maximum flux efficiency curve, setting the current command value in a region on a positive side of the q-axis relative to at least one of the constant torque curve and the maximum flux efficiency curve.
Feature 73: in the d-q coordinate system having the d-axis and the q-axis orthogonal to each other, in association with the measured value of the q-axis component, which is a component of the q-axis of the current, being included in the region on the positive side of the q-axis relative to the intersection of the given constant torque curve and the maximum flux efficiency curve, setting the current command value in a region on a positive side of the q-axis relative to both the constant torque curve and the maximum flux efficiency curve.

According to the control method including at least Features 59 to 73, effects similar to those of the electric work machine described above are achieved.

An embodiment may include at least one of the following features in addition to or in place of at least one of Features 59 to 73.
Feature 74: transitioning between two or more modes.
Feature 75: transitioning between two or more modes including a first mode, a second mode, and a third mode.
Feature 76: operating in one mode of the modes.
Feature 77: setting the current command value.
Feature 78: setting the current command value so as to maximize torque per unit current.
Feature 79: in the first mode, setting the current command value so as to maximize the torque per unit current.
Feature 80: setting the current command value so as to generate a magnetic field in a direction that reduces a magnetic field generated from a magnetic material of the rotor.
Feature 81: in the second mode, setting the current command value so as to generate a magnetic field in a direction that reduces the magnetic field generated from the magnetic material of the rotor.
Feature 82: in association with transitioning from the second mode to the first mode, operating so as to pass through the third mode.
Feature 83: in association with transitioning from the second mode to the third mode, storing a measured value of the current that was flowing through the stator as a reference measured value.
Feature 84: in association with transitioning from the second mode to the third mode, storing the current command value to be flowed through the stator as a reference command value.
Feature 85: in association with transitioning from the second mode to the third mode, storing the measured value of the current that was flowing through the stator and the current command value to be flowed through the stator as the reference measured value and the reference command value, respectively.
Feature 86: setting the current command value in the third mode based on at least one of the reference measured value or the reference command value.
Feature 87: setting the current command value in the third mode based on both the reference measured value and the reference command value.

According to the control method including at least Features 59 to 87, effects similar to those of the electric work machine described above are achieved.

In an embodiment, Features 59 to 87 may be combined in any manner.

In an embodiment, at least one of Features 59 to 87 may be excluded.

### 2. Specific Exemplary Embodiments

### 2-1. Configuration

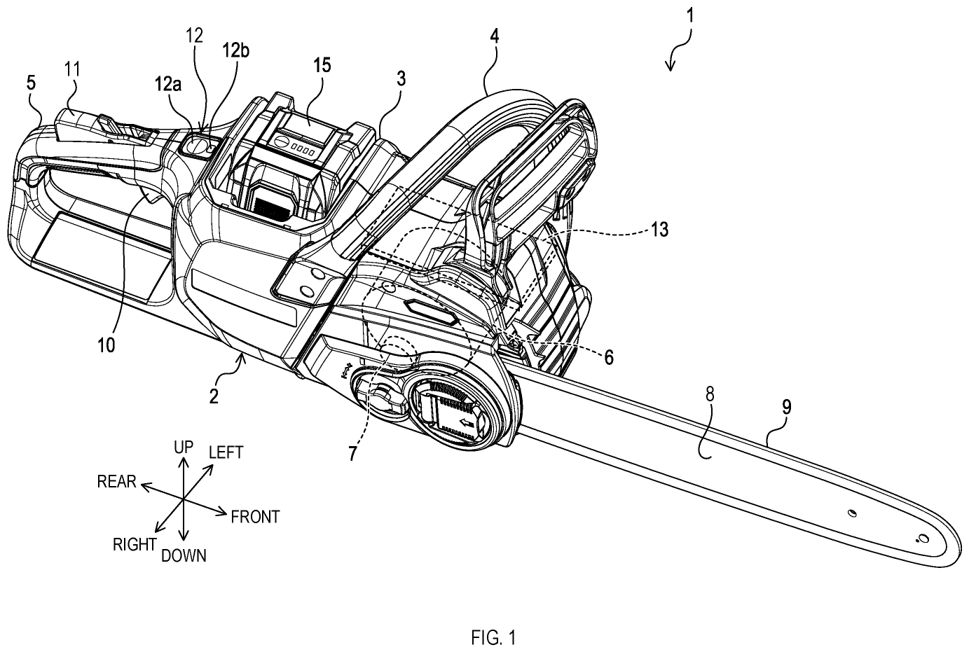

The following exemplary embodiments provide an electric work machine 1 shown in FIG. 1. The electric work machine 1 includes a motor 6. The motor 6 includes a mechanism configured to be driven by receiving electric power from a power supply. As an example, the electric work machine 1 of the present embodiment is in the form of an electric chainsaw. Other examples of the electric work machine 1 include an impact driver, a drill, a power cutter, a blower, a grass trimmer, a hedge trimmer, and the like. However, such an electric work machine 1 is merely an example, and the present disclosure can be applied to all forms of electric work machines.

In FIG. 1, directions such as “up,” “down,” “front,” “rear,” “left,” and “right” are shown, but these directions are shown merely to facilitate a better understanding of the structure of the electric work machine 1 and are not intended to limit the orientation of the electric work machine 1. The electric work machine 1 can be arranged in any orientation.

### [2-1-1. Mechanical Structure of Electric Work Machine]

As shown in FIG. 1, the electric work machine 1 includes a housing 2. The housing 2 houses therein the motor 6, a drive transmission 7, and a controller 13.

The electric work machine 1 includes a guide bar 8. The guide bar 8 is a plate-shaped member. The guide bar 8 protrudes forward from the housing 2 of the electric work machine 1.

The electric work machine 1 includes a saw chain 9. The saw chain 9 includes two or more cutters coupled to each other. The saw chain 9 is detachably attached to a peripheral portion of the guide bar 8.

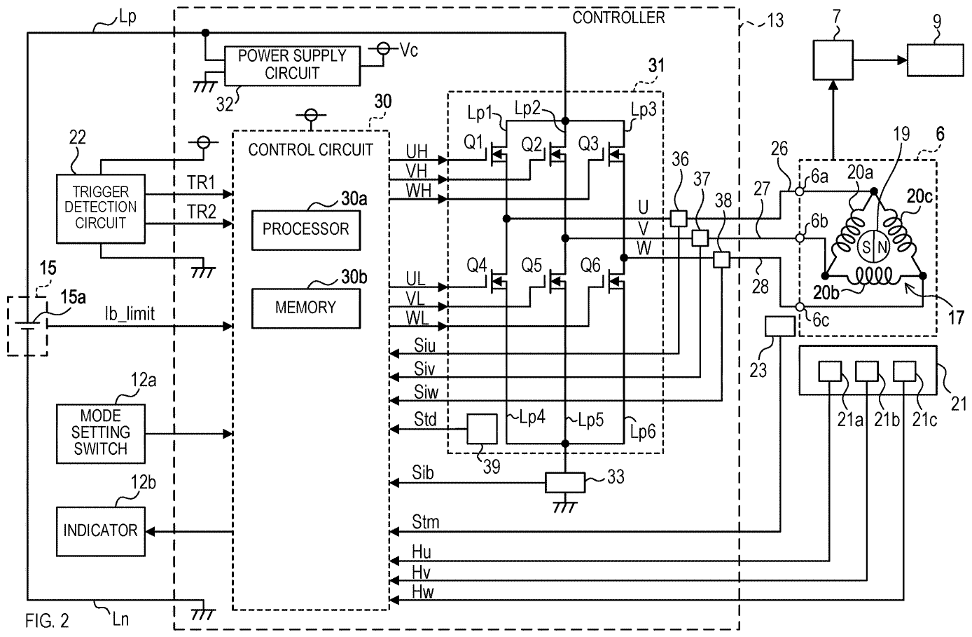

The drive transmission 7 is coupled directly or indirectly to the motor 6 (more specifically, a rotor 19, see FIG. 2). The drive transmission 7 includes a sprocket (not shown), to which the saw chain 9 is configured to be attached. The drive transmission 7 transmits rotation of the motor 6 (more specifically, rotation of the rotor 19) to the saw chain 9, thereby driving the saw chain 9. When the motor 6 is driven, the saw chain 9 moves along the peripheral portion of the guide bar 8. Thus, the saw chain 9 can perform its operation on a target object. Specifically, the saw chain 9 can cut workpieces such as wood, metal, and resin.

The housing 2 includes a battery attachment part 3 at a rear part thereof. A battery pack 15 is detachably attached to the battery attachment part 3. FIG. 1 shows a state where the battery pack 15 is attached to the battery attachment part 3. The battery pack 15 houses a battery 15a (see FIG. 2) that is repeatedly chargeable. The battery 15a includes, for example, a lithium-ion battery. While the battery pack 15 is attached to the battery attachment part 3, electric power from the battery 15a can be supplied to each part of the electric work machine 1.

The electric work machine 1 includes a front handle 4 at an upper part of the housing 2. The front handle 4 is gripped by a user of the electric work machine 1. The electric work machine 1 includes a rear handle 5 at a rear part of the housing 2. The rear handle 5 is gripped by the user. The user can use the electric work machine 1, for example, while gripping the front handle 4 with one hand (e.g., the left hand) and gripping the rear handle 5 with the other hand (e.g., the right hand).

The electric work machine 1 includes a trigger 10. The trigger 10 is manually operated by the user. Specifically, the trigger 10 is manually pulled upward. When the trigger 10 is manually operated (i.e., pulled), the motor 6 is driven. In the present embodiment, the trigger 10 is provided on the rear handle 5. Therefore, the user can manually operate the trigger 10 while gripping the rear handle 5.

The electric work machine 1 includes a lock-off lever 11 in the vicinity of the trigger 10. The lock-off lever 11 is manually operated (e.g., pushed downward) by the user. When the lock-off lever 11 is not manually operated by the user, the lock-off lever 11 restricts movement of the trigger 10. While the lock-off lever 11 is manually operated by the user, the restriction on the trigger 10 is released, and the user can manually operate the trigger 10. In the present embodiment, the lock-off lever 11 is provided on the rear handle 5. Therefore, the user can manually operate the trigger 10 while gripping the rear handle 5 and manually operating the lock-off lever 11.

The electric work machine 1 includes an operation panel 12. In the present embodiment, the operation panel 12 is disposed on an upper surface of a rear end of the housing 2. The operation panel 12 includes a mode setting switch 12a and an indicator 12b.

The mode setting switch 12a of the present embodiment is in the form of a momentary switch. The mode setting switch 12a outputs an operation signal while the mode setting switch 12a is being pressed. The mode setting switch 12a does not output the operation signal while the mode setting switch 12a is not being pressed.

The indicator 12b visually informs the user of the state of the electric work machine 1. The indicator 12b of the present embodiment includes an LED (not shown). In the following description, “lighting” and “turning off” of the indicator 12b mean “lighting” and “turning off” of the LED.

### [2-1-2. Electrical Configuration of Electric Work Machine]

The electrical configuration of the electric work machine 1 will be described with reference to FIG. 2. The electric work machine 1 includes the motor 6 and the controller 13 described above.

In the present embodiment, the motor 6 is an inner-rotor type brushless DC motor (more specifically, a three-phase brushless DC motor). In another embodiment, the motor 6 may be any other type of brushless DC motor (e.g., an outer-rotor type brushless DC motor).

The motor 6 includes a first coil 20a, a second coil 20b, and a third coil 20c. The first to third coils 20a, 20b, 20c are delta-connected to each other. However, the first to third coils 20a, 20b, 20c may be connected to each other in a manner different from the delta connection. The first to third coils 20a, 20b, 20c may be star-connected to each other, for example.

The motor 6 includes a stator 17. The stator 17 is configured to generate a magnetic field when current flows therethrough. Specifically, the stator 17 includes the first to third coils 20a, 20b, 20c. The stator 17 includes two or more teeth (not shown). The first to third coils 20a, 20b, 20c are wound around each of the teeth. The stator 17 generates a magnetic field by the current flowing through the first to third coils 20a, 20b, 20c.

The motor 6 includes a rotor 19. The rotor 19 is arranged to pass through the stator 17 and is rotatably supported by bearings (not shown). The rotor 19 includes one or more magnetic materials. The magnetic materials may include, for example, a permanent magnet, or may be a permanent magnet. That is, the rotor 19 has two or more magnetic poles along its rotational direction. Specifically, in the rotor 19, N-poles and S-poles are alternately arranged along the rotational direction. In the rotor 19 of FIG. 2, “N” schematically indicates an N-pole and “S” schematically indicates an S-pole. The rotor 19 rotates about the rotational axis in response to a change in the magnetic field generated from the stator 17.

For simplification of the explanation, FIG. 2 simply shows the motor 6 as if it is a brushless DC motor in the form of 2 poles and 3 slots (i.e., 3 teeth), but the brushless DC motor of the present disclosure actually has four or more magnetic poles and six or more slots (i.e., six or more teeth). Of course, the motor 6 may actually be in the form of 2 poles and 3 slots.

The motor 6 includes a first terminal 6a, a second terminal 6b, and a third terminal 6c. The first terminal 6a is coupled to a first end of the first coil 20a and a first end of the third coil 20c. The second terminal 6b is coupled to a second end of the first coil 20a and a first end of the second coil 20b. The third terminal 6c is coupled to a second end of the second coil 20b and a second end of the third coil 20c.

The electric work machine 1 includes a position signal output circuit 21. The position signal output circuit 21 is disposed in the vicinity of the motor 6 (more specifically, in the vicinity of the rotor 19).

The position signal output circuit 21 includes a first rotation sensor 21a, a second rotation sensor 21b, and a third rotation sensor 21c. Each of the first to third rotation sensors 21a to 21c is configured to detect magnetic flux density around the rotor 19 (that is, magnetic flux density around the magnetic material included in the rotor 19). In the present embodiment, each of the first to third rotation sensors 21a to 21c is a Hall sensor but is not limited to a Hall sensor.

The first to third rotation sensors 21a to 21c are arranged to be spaced apart from the rotor 19 by a given distance in a direction along the rotational axis. The first to third rotation sensors 21a to 21c are arranged to be spaced apart from each other by an electrical angle of 120 degrees along the rotational direction of the rotor 19.

The first rotation sensor 21a outputs a first Hall signal Hu, the second rotation sensor 21b outputs a second Hall signal Hv, and the third rotation sensor 21c outputs a third Hall signal Hw. Each of the first to third Hall signals Hu, Hv, Hw is in the form of a digital signal (i.e., a binary signal). The logical value of each of the first to third Hall signals Hu, Hv, Hw is inverted every time the rotor 19 rotates by 180 degrees in electrical angle. Phases of the first to third Hall signals Hu, Hv, Hw are shifted from each other by 120 degrees in electrical angle.

The electric work machine 1 includes a power supply line Lp. The power supply line Lp extends from the positive electrode of the battery pack 15 attached to the battery attachment part 3 to the controller 13. The electric work machine 1 includes a ground line Ln. The ground line Ln extends from the negative electrode of the battery pack 15 attached to the battery attachment part 3 to the controller 13. The battery pack 15 applies voltage (hereinafter referred to as “battery voltage”) between the power supply line Lp and the ground line Ln from the battery 15a.

The controller 13 includes a power supply circuit 32. The power supply circuit 32 is coupled to the power supply line Lp and receives the battery voltage through the power supply line Lp. The power supply circuit 32 generates a DC voltage based on the battery voltage. Hereinafter, the DC voltage is also referred to as a power supply voltage Vc.

The controller 13 includes a control circuit 30. The control circuit 30 operates by receiving the power supply voltage Vc. The control circuit 30 is a microcontroller including a processor 30a and a memory 30b. The memory 30b is in the form of a semiconductor memory. The memory 30b includes a ROM (Read Only Memory), a RAM (Random Access Memory), and a rewritable non-volatile memory. The non-volatile memory is, for example, an EEPROM (Electrically Erasable and Programmable Read Only Memory), a flash memory, an ReRAM (Resistive RAM), an FeRAM (Ferroelectric RAM), or the like. Various functions of the control circuit 30 are realized by the processor 30a executing a program stored in the memory 30b. A method corresponding to this program is executed by the processor 30a executing this program.

In another embodiment, the control circuit 30 may include an additional microcontroller. In still another embodiment, part or all of the functions achieved by the processor 30a may be achieved by one or more electronic components (e.g., integrated circuits). In still another embodiment, the control circuit 30 may be a logic circuit (or a wired logic connection) including two or more electronic components. In still another embodiment, the control circuit 30 may include an ASIC (Application Specific Integrated Circuit) and/or an ASSP (Application Specific Standard Product). In still another embodiment, the control circuit 30 may include a programmable logic device in which a reconfigurable logic circuit can be built. Examples of the programmable logic device include an FPGA (Field Programmable Gate Array).

The controller 13 includes a drive circuit 31. The drive circuit 31 is electrically coupled to the power supply line Lp and the ground line Ln and receives the battery voltage through the power supply line Lp and the ground line Ln. The drive circuit 31 is electrically coupled to the motor 6 through a first lead wire 26, a second lead wire 27, and a third lead wire 28. Specifically, the first lead wire 26 is coupled to a first terminal 6a of the motor 6. The second lead wire 27 is coupled to a second terminal 6b of the motor 6. The third lead wire 28 is coupled to a third terminal 6c of the motor 6.

The drive circuit 31 generates a three-phase voltage from the battery voltage (that is, generates three-phase power). The drive circuit 31 supplies the generated three-phase voltage to the motor 6 through the first to third lead wires 26 to 28. In the following description, the current flowing through the first lead wire 26 is referred to as a U-phase motor current, the current flowing through the second lead wire 27 is referred to as a V-phase motor current, and the current flowing through the third lead wire 28 is referred to as a W-phase motor current.

The drive circuit 31 of the present embodiment is a three-phase full-bridge circuit, but is not limited to the three-phase full-bridge circuit. The drive circuit 31 includes first to third current paths Lp1 to Lp3 as a so-called upper arm. The first to third current paths Lp1 to Lp3 electrically couple the power supply line Lp to the first to third terminals 6a, 6b, 6c of the motor 6, respectively.

The drive circuit 31 includes fourth to sixth current paths Lp4 to Lp6 as a so-called lower arm. The fourth to sixth current paths Lp4 to Lp6 electrically couple the ground line Ln to the first to third terminals 6a, 6b, 6c of the motor 6, respectively.

The drive circuit 31 includes a first switch Q1 on the first current path Lp1, a second switch Q2 on the second current path Lp2, a third switch Q3 on the third current path Lp3, a fourth switch Q4 on the fourth current path Lp4, a fifth switch Q5 on the fifth current path Lp5, and a sixth switch Q6 on the sixth current path Lp6.

Each of the first to third switches Q1 to Q3 functions as a so-called high-side switch. Each of the fourth to sixth switches Q4 to Q6 functions as a so-called low-side switch. The first to third current paths Lp1 to Lp3 are completed or interrupted by the first to third switches Q1 to Q3, respectively. The fourth to sixth current paths Lp4 to Lp6 are completed or interrupted by the fourth to sixth switches Q4 to Q6, respectively.

The first to sixth switches Q1 to Q6 are semiconductor switches. In the present embodiment, the first to sixth switches Q1 to Q6 are in the form of n-channel metal oxide semiconductor field effect transistors (MOSFETs). However, the first to sixth switches Q1 to Q6 may be other forms of semiconductor switches, such as bipolar transistors and insulated gate bipolar transistors (IGBTs).

The first switch Q1 receives a first drive signal UH from the control circuit 30 and is turned on or off according to the first drive signal UH. The second switch Q2 receives a second drive signal VH from the control circuit 30 and is turned on or off according to the second drive signal VH. The third switch Q3 receives a third drive signal WH from the control circuit 30 and is turned on or off according to the third drive signal WH. The fourth switch Q4 receives a fourth drive signal UL from the control circuit 30 and is turned on or off according to the fourth drive signal UL. The fifth switch Q5 receives a fifth drive signal VL from the control circuit 30 and is turned on or off according to the fifth drive signal VL. The sixth switch Q6 receives a sixth drive signal WL from the control circuit 30 and is turned on or off according to the sixth drive signal WL. In the present embodiment, the first to sixth drive signals UH, VH, WH, UL, VL, WL may be PWM (Pulse Width Modulation) signals.

When the motor 6 is driven, basically, any one of the high-side switches and any one of the low-side switches are turned on. As a result, a current (hereinafter, this current is referred to as “bus current”) flows from the positive electrode of the battery pack 15 through the high-side switch, the motor 6, and the low-side switch to the negative electrode of the battery pack 15, whereby the motor 6 rotates.

The drive circuit 31 includes a first current detection circuit 36 on the first lead wire 26. The first current detection circuit 36 detects the current flowing through the first lead wire 26 (hereinafter referred to as “U-phase current”). Specifically, the first current detection circuit 36 outputs a U-phase current detection signal Siu corresponding to the magnitude of the U-phase current. The U-phase current detection signal Siu is input to the control circuit 30.

The drive circuit 31 includes a second current detection circuit 37 on the second lead wire 27. The second current detection circuit 37 detects the current flowing through the second lead wire 27 (hereinafter referred to as “V-phase current”). Specifically, the second current detection circuit 37 outputs a V-phase current detection signal Siv corresponding to the magnitude of the V-phase current. The V-phase current detection signal Siv is input to the control circuit 30.

The drive circuit 31 includes a third current detection circuit 38 on the third lead wire 28. The third current detection circuit 38 detects the current flowing through the third lead wire 28 (hereinafter referred to as “W-phase current”). Specifically, the third current detection circuit 38 outputs a W-phase current detection signal Siw corresponding to the magnitude of the W-phase current. The W-phase current detection signal Siw is input to the control circuit 30.

The controller 13 includes a bus current detection circuit 33. The bus current detection circuit 33 is on a current path through which the bus current flows. In the present embodiment, the bus current detection circuit 33 is on the ground line Ln in the controller 13, more specifically, on a current path between the drive circuit 31 and the ground. The bus current detection circuit 33 detects the bus current. Specifically, the bus current detection circuit 33 outputs a bus current detection signal Sib corresponding to the magnitude of the bus current. The bus current detection signal Sib is input to the control circuit 30.

The controller 13 includes a first temperature detection circuit 39. The first temperature detection circuit 39 is provided inside or in the vicinity of the drive circuit 31. The first temperature detection circuit 39 includes a first temperature sensor (not shown). The first temperature sensor is, for example, a thermistor. The first temperature sensor outputs a first temperature detection signal Std corresponding to the temperature around the first temperature sensor. The first temperature detection signal Std is input to the control circuit 30. The first temperature detection signal Std directly or indirectly indicates the temperatures of the first to sixth switches Q1 to Q6 (in other words, the temperature of the drive circuit 31). That is, the first temperature detection circuit 39 is provided to detect the temperature of the drive circuit 31.

The electric work machine 1 includes a second temperature detection circuit 23. The second temperature detection circuit 23 is provided inside or in the vicinity of the motor 6. The second temperature detection circuit 23 includes a second temperature sensor (not shown). The second temperature sensor is, for example, a thermistor. The second temperature sensor outputs a second temperature detection signal Stm corresponding to the temperature around the second temperature sensor. The second temperature detection signal Stm is input to the control circuit 30. The second temperature detection signal Stm directly or indirectly indicates the temperature of the motor 6. That is, the second temperature detection circuit 23 is provided to detect the temperature of the motor 6.

The electric work machine 1 includes a trigger detection circuit 22. The trigger detection circuit 22 is mechanically coupled to the trigger 10 and outputs a first trigger signal TR1 and a second trigger signal TR2 corresponding to the state of the trigger 10. The first trigger signal TR1 is a binary signal indicating whether the trigger 10 is being manually operated. For example, while the trigger 10 is not being manually operated, the first trigger signal TR1 is at a low level, and while the trigger 10 is being manually operated, the first trigger signal TR1 is at a high level. The second trigger signal TR2 is an analog signal corresponding to the movement amount (in other words, pulling amount) of the trigger 10 from the initial position while the trigger 10 is being manually operated.

The first and second trigger signals TR1 and TR2 are input to the control circuit 30. The control circuit 30 can obtain whether the trigger 10 is turned on (that is, manually operated) and the movement amount of the trigger 10 when the trigger 10 is manually operated based on the first and second trigger signals TR1 and TR2.

The mode setting switch 12a and the indicator 12b described above are electrically coupled to the control circuit 30. The control circuit 30 receives an operation signal from the mode setting switch 12a. The control circuit 30 can recognize whether the mode setting switch 12a is being pressed based on the presence or absence of the operation signal.

In the present embodiment, even if the battery pack 15 is attached to the battery attachment part 3, the power supply voltage Vc is not generated immediately. After the battery pack 15 is attached, in response to the mode setting switch 12a being pressed for a long time (long press), the power supply voltage Vc is generated, thereby starting the control circuit 30. The long press means, for example, that the mode setting switch 12a is continuously kept pressed for a first prescribed time (e.g., 2 to 3 seconds) or longer.

The control circuit 30 sets the operation mode of the electric work machine 1 to either a high-speed mode or a high-torque mode. Specifically, when the control circuit 30 is started by receiving the power supply voltage Vc, the control circuit 30 sets the operation mode to the high-speed mode. Then, every time the mode setting switch 12a is pressed for a short time (short press), the operation mode of the electric work machine 1 is alternately switched between the high-torque mode and the high-speed mode. The short press means, for example, that the pressing operation of the mode setting switch 12a is released before a second prescribed time elapses after the mode setting switch 12a is pressed. The second prescribed time is less than the first prescribed time.

The control circuit 30 controls the indicator 12b (specifically, an LED in the present embodiment) according to the state of the electric work machine 1. For example, the control circuit 30 lights the indicator 12b in a first manner while the operation mode is set to the high-speed mode and lights the indicator 12b in a second manner while the operation mode is set to the high-torque mode. The first manner may be, for example, a manner of lighting the LED in a first color (e.g., green). The second manner may be, for example, a manner of lighting the LED in a second color (e.g., yellow).

Note that the high-speed mode is a mode in which priority is given to rotating the motor 6 at a higher speed, and the high-torque mode is a mode in which priority is given to rotating the motor 6 at a higher torque. The high-speed mode and the high-torque mode will be described below in detail.

The control circuit 30 receives the first to third Hall signals Hu, Hv, Hw from the position signal output circuit 21. As described above, the phases of the first to third Hall signals Hu, Hv, Hw are shifted from each other by 120 degrees in electrical angle. Therefore, every time the rotor 19 rotates by 60 degrees in electrical angle, the logical value of any one of the first to third Hall signals Hu, Hv, Hw changes. The control circuit 30 detects the rotational position (in other words, rotational angle) and the rotational speed of the motor 6 based on the change in the logical value occurring every 60 degrees.

The control circuit 30 further receives the first temperature detection signal Std and the second temperature detection signal Stm described above. The control circuit 30 further receives the U-phase current detection signal Siu, the V-phase current detection signal Siv, and the W-phase current detection signal Siw described above.

The control circuit 30 controls the rotation of the motor 6 based on various input signals as described below.

### [2-1-3. Functional Configuration of Control Circuit]

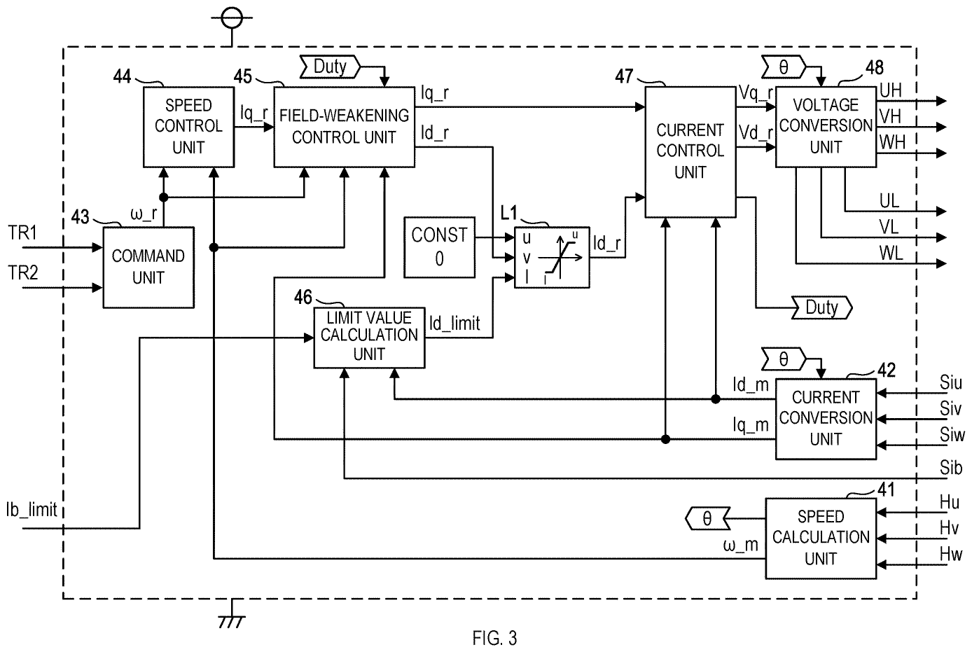

As shown in FIG. 3, the control circuit 30 has two or more functions. Specifically, the control circuit 30 includes functions of a speed calculation unit 41, a current conversion unit 42, a command unit 43, a speed control unit 44, a field-weakening control unit 45, a limit value calculation unit 46, a current control unit 47, and a voltage conversion unit 48. In the present embodiment, these functions are incorporated in the control circuit 30 by software. That is, these functions are realized by the processor 30a executing corresponding programs. Specific processes of these functions will be described below.

In another embodiment, at least one of the functions of the speed calculation unit 41, the current conversion unit 42, the command unit 43, the speed control unit 44, the field-weakening control unit 45, the limit value calculation unit 46, the current control unit 47, and the voltage conversion unit 48 may be incorporated in the control circuit 30 by hardware (that is, an electronic circuit) instead of software. Alternatively, in another embodiment, at least one of the functions of the speed calculation unit 41, the current conversion unit 42, the command unit 43, the speed control unit 44, the field-weakening control unit 45, the limit value calculation unit 46, the current control unit 47, and the voltage conversion unit 48 may be deleted.

The first to third Hall signals Hu, Hv, Hw are input to the speed calculation unit 41 from the position signal output circuit 21 (see FIG. 2). The speed calculation unit 41 calculates a rotational angle θ and a measured speed value ω_m of the rotor 19 based on the first to third Hall signals Hu, Hv, Hw. The measured speed value ω_m is a measured value of the rotational speed of the rotor 19. The unit of the measured speed value ω_m is, for example, rpm (revolution per minute). A method of calculating the rotational angle θ and the measured speed value ω_m based on the first to third Hall signals Hu, Hv, Hw is not particularly limited, and may be a publicly known method. The speed calculation unit 41 outputs the calculated rotational angle θ to the current conversion unit 42 and the voltage conversion unit 48, and outputs the calculated measured speed value ω_m to the speed control unit 44 and the field-weakening control unit 45.

Detection values of three-phase currents of U, V, W phases are input to the current conversion unit 42. The detection values of the three-phase currents input to the current conversion unit 42 are the U, V, W phase current detection signals Siu, Siv, Siw from the first to third current detection circuits 36, 37, 38. The U, V, W phase current detection signals Siu, Siv, Siw indicate detection values of the U, V, W phase currents detected by the first to third current detection circuits 36, 37, 38, that is, measured values of the U, V, W phase currents.

The current conversion unit 42 converts the detection values of the three-phase currents of U, V, W phases into two-phase currents Id and Iq of a d-axis current Id and a q-axis current Iq in the d-q coordinate system. The current conversion unit 42 converts the detection values of the three-phase currents into the two-phase currents Id and Iq by, for example, Clarke transformation and Park transformation.

The d-q coordinate system is a well-known rotation coordinate system having a d-axis and a q-axis orthogonal to each other. The d-axis represents a magnetic flux direction of the magnetic material of the rotor 19 of the motor 6. The negative direction of the d-axis is a direction that reduces the magnetic flux generated from the magnetic material of the rotor 19. The q-axis represents a direction in which torque is generated in the rotor 19. The positive direction of the q-axis is not particularly limited. For example, a direction of torque applied to the rotor 19 for accelerating the motor 6 may be the positive direction of the q-axis, and a direction opposite to the direction of the torque may be the negative direction of the q-axis. The d-axis current Id is a d-axis component of a current vector I. The q-axis current Iq is a q-axis component of the current vector I.

Specifically, the current conversion unit 42 calculates a d-axis current measured value Id_m as the d-axis current Id and calculates a q-axis current measured value Iq_m as the q-axis current Iq based on the U, V, W phase current detection signals Siu, Siv, Siw. The current conversion unit 42 outputs the calculated d-axis current measured value Id_m to the limit value calculation unit 46 and the current control unit 47, and outputs the calculated q-axis current measured value Iq_m to the field-weakening control unit 45 and the current control unit 47.

The first trigger signal TR1 and the second trigger signal TR2 of the trigger 10 are input to the command unit 43. The command unit 43 calculates a speed command value ω_r based on the first trigger signal TR1 and the second trigger signal TR2. The speed command value ω_r is a command value of the rotational speed for the rotor 19. When the first trigger signal TR1 indicates that the trigger 10 is not being manually operated, the command unit 43 calculates the speed command value ω_r as 0 (zero). When the first trigger signal TR1 indicates that the trigger 10 is being manually operated, the command unit 43 calculates the speed command value ω_r such that it becomes a greater value as the pulling amount of the trigger 10 indicated by the second trigger signal TR2 is greater. The command unit 43 outputs the calculated speed command value ω_r to the speed control unit 44 and the field-weakening control unit 45.

The speed command value ω_r and the measured speed value ω_m are input to the speed control unit 44. The speed control unit 44 calculates a q-axis current command value Iq_r based on the speed command value ω_r and the measured speed value ω_m. The speed control unit 44 calculates the q-axis current command value Iq_r by, for example, PI control (Proportional-Integral control). The speed control unit 44 outputs the calculated q-axis current command value Iq_r to the field-weakening control unit 45.

The q-axis current command value Iq_r, the q-axis current measured value Iq_m, the speed command value ω_r, the measured speed value ω_m, and a duty ratio Duty are input to the field-weakening control unit 45. The field-weakening control unit 45 calculates the q-axis current command value Iq_r and a d-axis current command value Id_r based on the q-axis current command value Iq_r, the q-axis current measured value Iq_m, the speed command value ω_r, the measured speed value ω_m, and the duty ratio Duty. A specific process performed by the field-weakening control unit 45 will be described below. The field-weakening control unit 45 outputs the calculated d-axis current command value Id_r to a first limiter L1 and outputs the q-axis current command value Iq_r to the current control unit 47.

The bus current detection signal Sib, a bus current upper limit value Ib_limit, and the d-axis current measured value Id_m are input to the limit value calculation unit 46. The limit value calculation unit 46 calculates a d-axis current limit value Id_limit based on the bus current detection signal Sib, the bus current upper limit value Ib_limit, and the d-axis current measured value Id_m. The bus current upper limit value Ib_limit is an upper limit value of the bus current. The bus current upper limit value Ib_limit can be obtained from the battery pack 15. The bus current upper limit value Ib_limit changes dynamically according to the measured speed value ω_m of the rotor 19. The d-axis current limit value Id_limit is an upper limit value and/or a lower limit value of the d-axis current Id that can be flowed to the control circuit 30. A specific process performed by the limit value calculation unit 46 will be described below. The limit value calculation unit 46 outputs the calculated d-axis current limit value Id_limit to the first limiter L1.

The d-axis current command value Id_r and the d-axis current limit value Id_limit are input to the first limiter L1. The first limiter L1 calculates the d-axis current command value Id_r, which is restricted so that the upper limit value is “zero” and the lower limit value is the d-axis current limit value Id_limit, based on the d-axis current command value Id_r and the d-axis current limit value Id_limit. The first limiter L1 outputs the calculated d-axis current command value Id_r to the current control unit 47.

The q-axis current command value Iq_r, the q-axis current measured value Iq_m, the d-axis current command value Id_r, and the d-axis current measured value Id_m are input to the current control unit 47. The current control unit 47 calculates a q-axis voltage command value Vq_r, a d-axis voltage command value Vd_r, and a duty ratio Duty based on the q-axis current command value Iq_r, the q-axis current measured value Iq_m, the d-axis current command value Id_r, and the d-axis current measured value Id_m. The duty ratio Duty calculated here is a duty ratio Duty of the first to sixth drive signals UH, VH, WH, UL, VL, WL. The current control unit 47 calculates the q-axis voltage command value Vq_r, the d-axis voltage command value Vd_r, and the duty ratio Duty by, for example, PI control. The current control unit 47 outputs the calculated q-axis voltage command value Vq_r and d-axis voltage command value Vd_r to the voltage conversion unit 48 and outputs the calculated duty ratio Duty to the field-weakening control unit 45.

The q-axis voltage command value Vq_r, the d-axis voltage command value Vd_r, and the rotational angle θ are input to the voltage conversion unit 48. The voltage conversion unit 48 calculates a three-phase voltage command value based on the q-axis voltage command value Vq_r, the d-axis voltage command value Vd_r, and the rotational angle θ. The voltage conversion unit 48 converts two-phase voltage of the q-axis voltage command value Vq_r and the d-axis voltage command value Vd_r into the three-phase voltage command value by, for example, inverse Clarke transformation and inverse Park transformation. The voltage conversion unit 48 outputs the calculated three-phase voltage command value to the drive circuit 31 (see FIG. 2) as the first to sixth drive signals UH, VH, WH, UL, VL, WL, and supplies a three-phase voltage to the motor 6 through the drive circuit 31.

### [2-1-4. Configuration of Limit Value Calculation Unit]

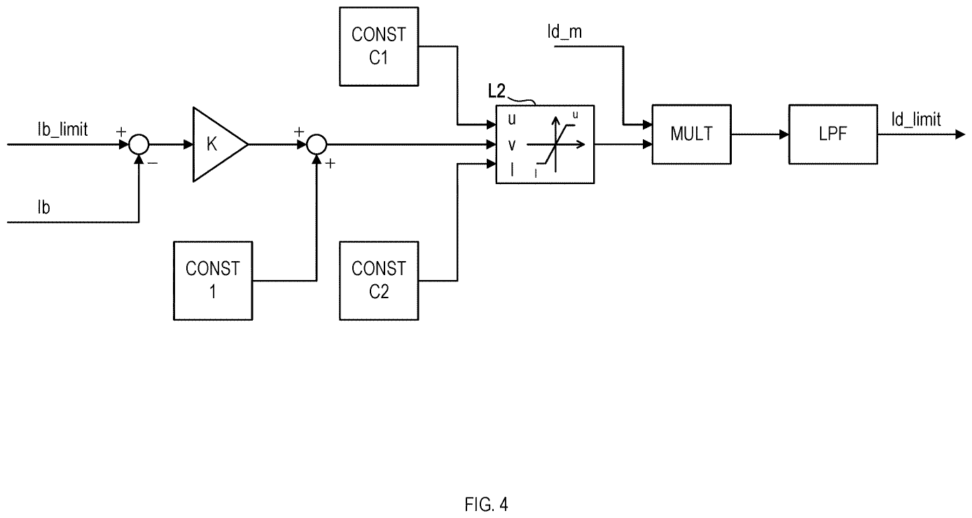

A specific process performed by the limit value calculation unit 46 will be described with reference to FIG. 4.

First, the limit value calculation unit 46 obtains the bus current detection signal Sib and the bus current upper limit value Ib_limit and calculates a difference between a bus current value Ib, which is a current value indicated by the bus current detection signal Sib, and the bus current upper limit value Ib_limit. The calculated current difference is attenuated by a gain K. The gain K, for example, attenuates the input value by 0.001 times.

Subsequently, the limit value calculation unit 46 adds a constant value “one” to the current difference attenuated by the gain K and inputs it to a second limiter L2. A constant C1 and a constant C2 are input to an upper limit value and a lower limit value of the second limiter L2, respectively. The constants C1 and C2 are set so as to satisfy (C1+C2)/2=1. For example, C1=2 and C2=0.

Subsequently, the limit value calculation unit 46 inputs a value obtained by multiplying an output value of the second limiter L2 and the d-axis current measured value Id_m by a multiplier MULT to a low-pass filter LPF and calculates the d-axis current limit value Id_limit as an output. The cutoff frequency of the low-pass filter LPF is set to, for example, 100 Hz.

In this way, the limit value calculation unit 46 calculates the d-axis current limit value Id_limit based on the bus current detection signal Sib, the bus current upper limit value Ib_limit, and the d-axis current measured value Id_m.

### 2-2. Process

### [2-2-1. Interruption Process]

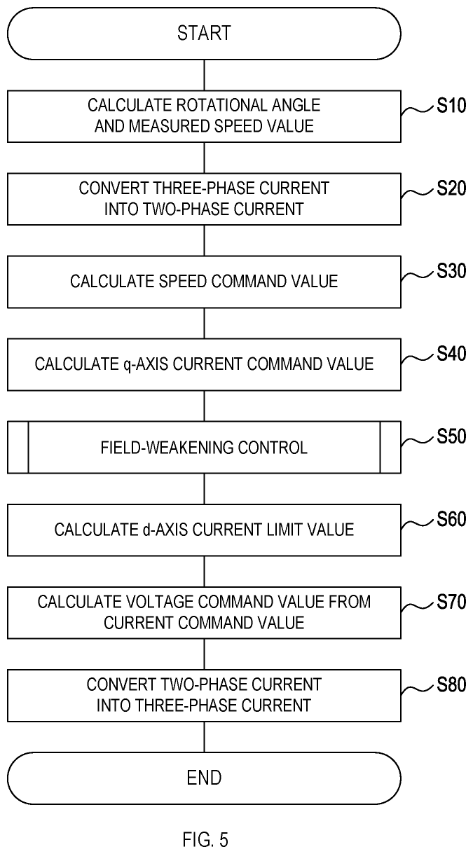

A series of processes executed by the processor 30a of the control circuit 30 will be described with reference to FIG. 5 to FIG. 11.

The control circuit 30 repeats an interruption process shown in FIG. 5 at a constant cycle. The constant cycle is, for example, 20 kHz, 10 kHz, or the like.

First, in S10, the control circuit 30 calculates the rotational angle θ and the measured speed value ω_m of the rotor 19 by the speed calculation unit 41. The rotational angle θ and the measured speed value ω_m are calculated based on the first to third Hall signals Hu, Hv, Hw.

Subsequently, in S20, the control circuit 30 converts the three-phase current indicated by the U, V, W phase current detection signals Siu, Siv, Siw into two-phase currents Id and Iq of the d-axis current Id and the q-axis current Iq by the current conversion unit 42.

Subsequently, in S30, the control circuit 30 calculates the speed command value ω_r by the command unit 43. The speed command value ω_r is calculated based on the first trigger signal TR1 and the second trigger signal TR2.

Subsequently, in S40, the control circuit 30 calculates the q-axis current command value Iq_r by the speed control unit 44. The q-axis current command value Iq_r is calculated based on the speed command value ω_r.

Subsequently, in S50, the control circuit 30 calculates the q-axis current command value Iq_r and the d-axis current command value Id_r by the field-weakening control unit 45. The q-axis current command value Iq_r and the d-axis current command value Id_r are calculated based on the q-axis current command value Iq_r, the q-axis current measured value Iq_m, the speed command value ω_r, the measured speed value ω_m, and the duty ratio Duty. A specific process of S50 will be described below.

Subsequently, in S60, the control circuit 30 calculates the d-axis current limit value Id_limit by the limit value calculation unit 46. The d-axis current limit value Id_limit is calculated based on the bus current detection signal Sib, the bus current upper limit value Ib_limit, and the d-axis current measured value Id_m.

Subsequently, in S70, the control circuit 30 calculates the q-axis voltage command value Vq_r, the d-axis voltage command value Vd_r, and the duty ratio Duty by the current control unit 47. The q-axis voltage command value Vq_r, the d-axis voltage command value Vd_r, and the duty ratio Duty are calculated based on the q-axis current command value Iq_r, the q-axis current measured value Iq_m, the d-axis current command value Id_r, and the d-axis current measured value Id_m.

Subsequently, in S80, the control circuit 30 converts the two-phase voltage of the q-axis voltage command value Vq_r and the d-axis voltage command value Vd_r into the three-phase voltage command value by the voltage conversion unit 48. The control circuit 30 outputs the converted three-phase voltage command value to the drive circuit 31 as the first to sixth drive signals UH, VH, WH, UL, VL, WL and supplies a three-phase voltage to the motor 6 through the drive circuit 31.

Then, the control circuit 30 ends the interruption process shown in FIG. 5.

In this way, the control circuit 30 controls the d-axis current Id and the q-axis current Iq of the current vector I flowing through the motor 6 based on the U, V, W phase current detection signals Siu, Siv, Siw, which are measured values of the three-phase currents flowing through the motor 6, the first to third Hall signals Hu, Hv, Hw representing the magnetic flux density around the rotor 19, the first trigger signal TR1 and the second trigger signal TR2 according to the state of the trigger 10, and the bus current detection signal Sib, thereby controlling the three-phase voltage supplied to the motor 6.

### [2-2-2. Operation Modes of Control Circuit]

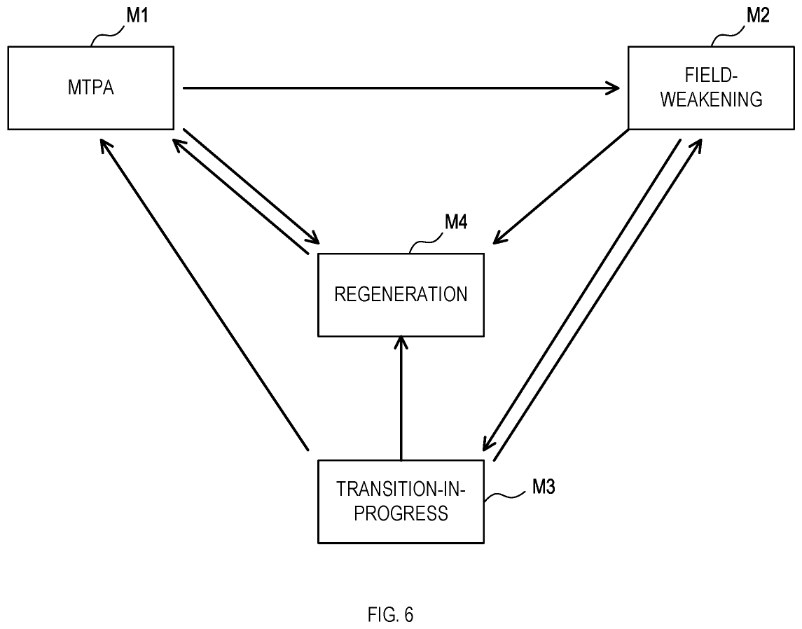

As shown in FIG. 6, the control circuit 30 has, as operation modes, an MTPA mode M1, a field-weakening mode M2, a transition-in-progress mode M3, and a regeneration mode M4. The control circuit 30 operates in one of these modes. However, the modes are not limited to these modes and may include other operation modes. The control circuit 30 does not have to have the regeneration mode M4 as an operation mode.

The MTPA mode M1 is an operation mode for controlling the motor 6 by so-called MTPA (Maximum Torque Per Ampere) control. That is, in the MTPA mode M1, the control circuit 30 sets the d-axis current command value Id_r so as to maximize the torque per unit current of the motor 6.

The field-weakening mode M2 is an operation mode for controlling the motor 6 by so-called field-weakening control. That is, the field-weakening mode M2 is an operation mode for controlling the d-axis current command value Id_r so as to generate a magnetic field in the stator 17 in a direction that reduces the magnetic field generated from the magnetic material of the rotor 19.

The transition-in-progress mode M3 is an operation mode through which the control circuit 30 passes when transitioning from the field-weakening mode M2 to the MTPA mode M1. That is, the control circuit 30 operates so as to pass through the transition-in-progress mode M3 when transitioning from the field-weakening mode M2 to the MTPA mode M1.

The regeneration mode M4 is an operation mode for attenuating the rotational speed, torque, and the like of the motor 6. For example, when the user of the electric work machine 1 manually operates the trigger 10 from a state of being pulled to a state of not being pulled, the control circuit 30 operates in the regeneration mode M4.

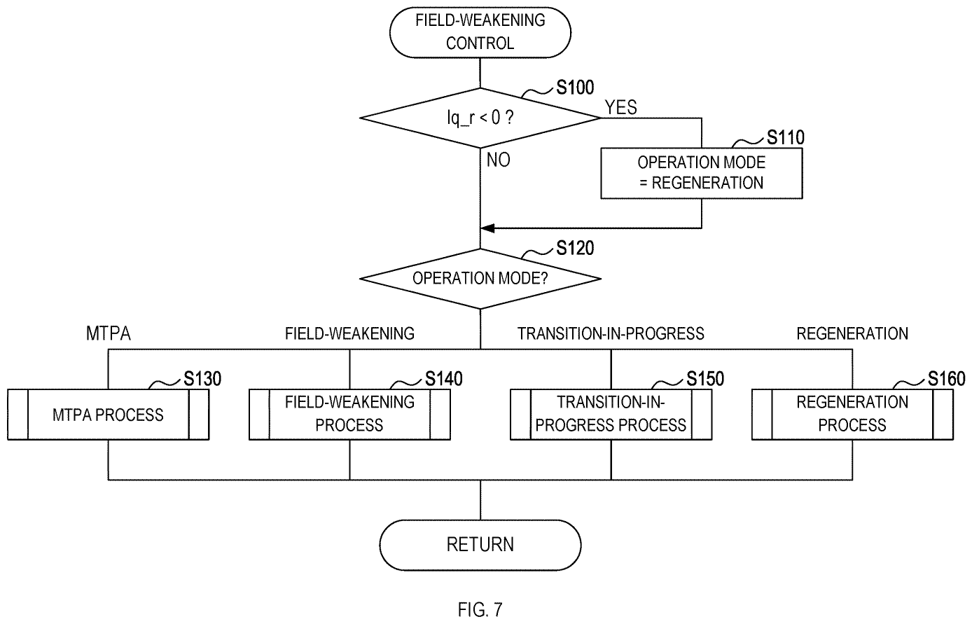

The control circuit 30 transitions between the MTPA mode M1, the field-weakening mode M2, the transition-in-progress mode M3, and the regeneration mode M4 according to processes shown in FIG. 7 to FIG. 11 described below. The initial state of the control circuit 30 is the MTPA mode M1.

The control circuit 30 operating in the MTPA mode M1 can transition to the field-weakening mode M2 or the regeneration mode M4.

The control circuit 30 operating in the field-weakening mode M2 can transition to the transition-in-progress mode M3 or the regeneration mode M4.

The control circuit 30 operating in the transition-in-progress mode M3 can transition to the MTPA mode M1, the field-weakening mode M2, or the regeneration mode M4.

The control circuit 30 operating in the regeneration mode M4 can transition to the MTPA mode M1.

### [2-2-3. Field-Weakening Control Process]

In S50 in FIG. 5, the control circuit 30 executes a field-weakening control process shown in FIG. 7. In the field-weakening control process, the control circuit 30 executes a process according to the operation mode.

First, in S100, the control circuit 30 determines whether the q-axis current command value Iq_r is less than zero.

If the control circuit 30 determines that the q-axis current command value Iq_r is less than zero (S100: YES), the control circuit 30 proceeds to S110 and transitions to the regeneration mode M4. Then, the control circuit 30 proceeds to S120.

If the control circuit 30 determines that the q-axis current command value Iq_r is not less than zero (S100: NO), the control circuit 30 proceeds to S120.

Subsequently, in S120, the control circuit 30 determines what the current operation mode is.

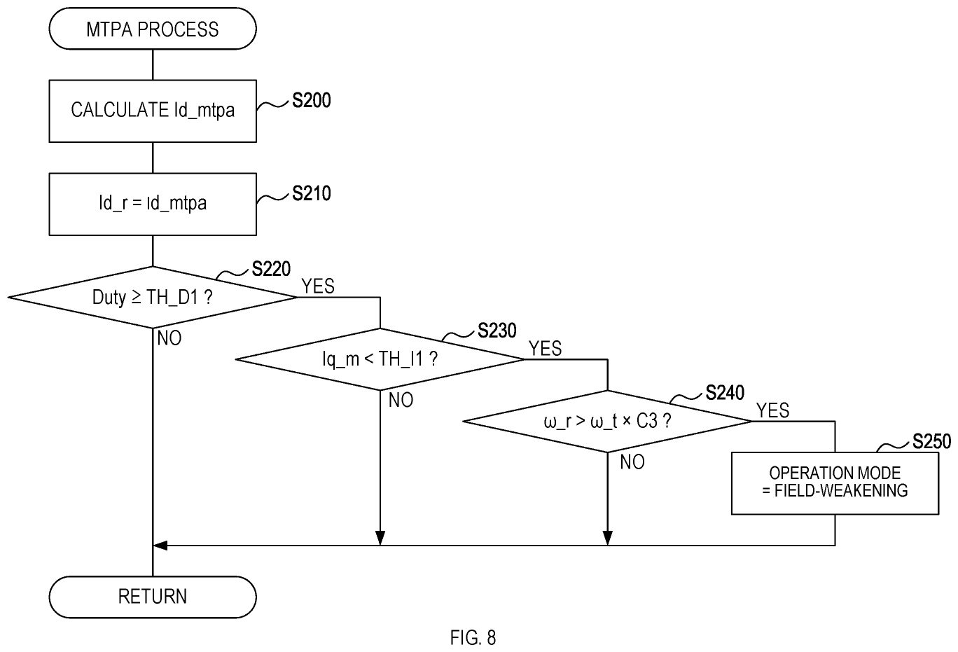

If the operation mode is the MTPA mode M1, the control circuit 30 proceeds to S130 and executes an MTPA process shown in FIG. 8.

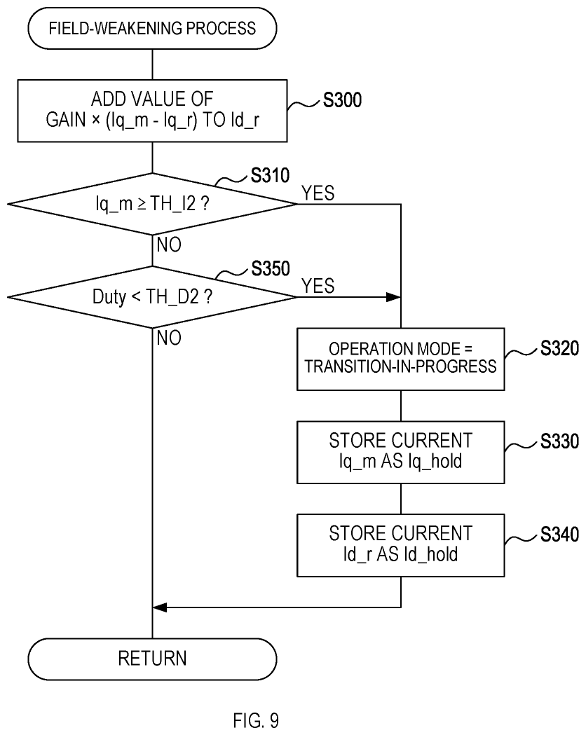

If the operation mode is the field-weakening mode M2, the control circuit 30 proceeds to S140 and executes a field-weakening process shown in FIG. 9.

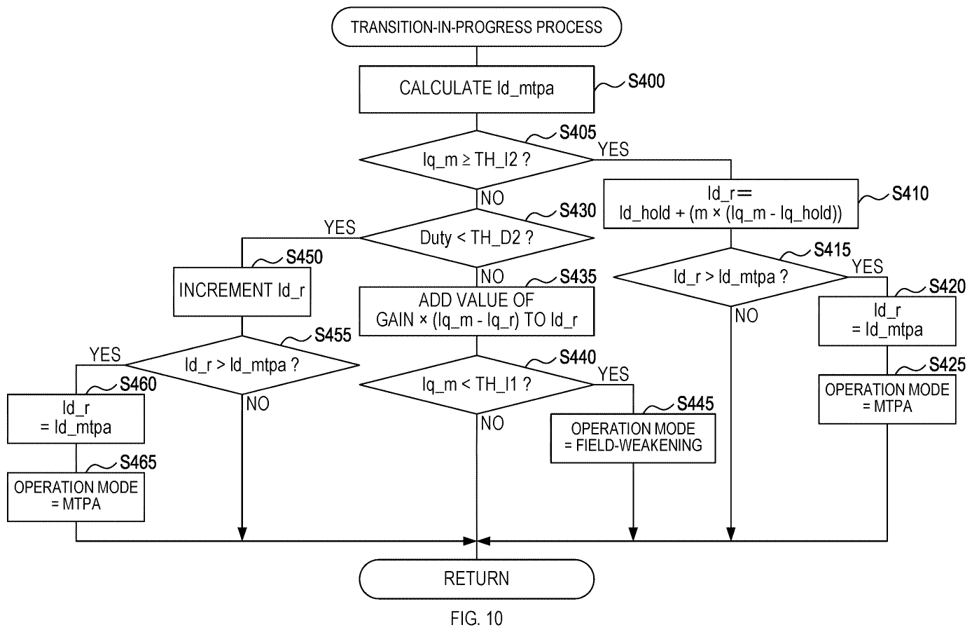

If the operation mode is the transition-in-progress mode M3, the control circuit 30 proceeds to S150 and executes a transition-in-progress process shown in FIG. 10.

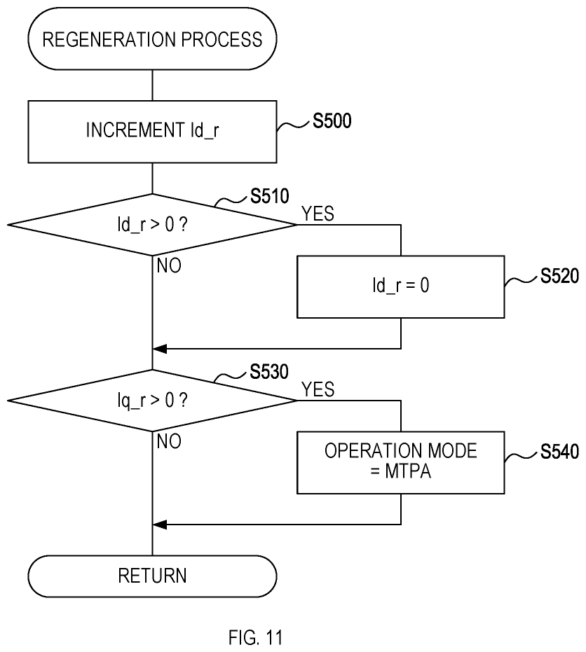

If the operation mode is the regeneration mode M4, the control circuit 30 proceeds to S160 and executes a regeneration process shown in FIG. 11.

Details of each of the MTPA process, the field-weakening process, the transition-in-progress process, and the regeneration process will be described below.

Then, the control circuit 30 ends the field-weakening control process shown in FIG. 7.

In this way, the control circuit 30 executes the process according to the operation mode.

### [2-2-4. MTPA Process]

The MTPA process executed by the control circuit 30 will be described with reference to the flowchart in FIG. 8. The MTPA process is a process of the control circuit 30 in the MTPA mode M1.

First, in S200, the control circuit 30 calculates an MTPA current value Id_mtpa, which is a d-axis current value during an MTPA control. The MTPA current value Id_mtpa can be calculated by substituting the q-axis current command value Iq_r into the q-axis current Iq in the following Equation 1.

$$[ Equation 1 ]$$

$${I}_{d \_ mtpa} = \frac{{Ψ}_{a}}{2 ( {L}_{q} - {L}_{d} )} - \sqrt{{( \frac{{Ψ}_{a}}{2 ( {L}_{q} - {L}_{d} )} )}^{2} + {I}_{q}^{2}} \qquad ( 1 )$$

In Equation 1, Ψa is a d-axis component of a magnetic flux vector of the magnetic material in the rotor 19. Lq is a q-axis inductance. Ld is a d-axis inductance. The unit of Ψa is, for example, Weber. The unit of Lq and Ld is, for example, Henry.

The control circuit 30 may create a table in advance in which the MTPA current value Id_mtpa corresponding to the q-axis current Iq is calculated and calculate the MTPA current value Id_mtpa based on the q-axis current command value Iq_r by referring to the table.

Subsequently, in S210, the control circuit 30 sets the MTPA current value Id_mtpa to the d-axis current command value Id_r Subsequently, in S220, the control circuit 30 determines whether the duty ratio Duty is greater than or equal to a first duty threshold value TH_D1.

The first duty threshold value TH_D1 is a threshold value for determining whether the voltage output from the drive circuit 31 is saturated. The first duty threshold value TH_D1 is, for example, 98%.

If the duty ratio Duty is not greater than or equal to the first duty threshold value TH_D1 (S220: NO), the control circuit 30 ends the MTPA process shown in FIG. 8.

Meanwhile, if the duty ratio Duty is greater than or equal to the first duty threshold value TH_D1 (S220: YES), the control circuit 30 proceeds to S230 and determines whether the q-axis current measured value Iq_m is less than a first current threshold value TH_I1.

The first current threshold value TH_I1 is a threshold value for determining whether the control circuit 30 transitions to the field-weakening mode M2. The first current threshold value TH_I1 is, for example, 20 amperes.

If the q-axis current measured value Iq_m is not less than the first current threshold value TH_I1 (S230: NO), the control circuit 30 ends the MTPA process shown in FIG. 8.

Meanwhile, if the q-axis current measured value Iq_m is less than the first current threshold value TH_I1 (S230: YES), the control circuit 30 proceeds to S240 and determines whether the speed command value ω_r is greater than a speed target value ω_t multiplied by a constant C3.

The speed target value ω_t is a threshold value for determining whether the motor 6 is in an acceleration state. When the user first pulls the trigger 10, the motor 6 is in the acceleration state. While the motor 6 is in the acceleration state, the control circuit 30 operates in the MTPA mode M1. If the field-weakening process is performed while the motor 6 is in the acceleration state, the motor 6 cannot output torque and thus cannot accelerate. For this reason, while the speed command value ω_r exceeds a given target value, the control circuit 30 controls so as not to transition to the field-weakening mode M2. The speed target value ω_t is, for example, about 35000 rpm.

The constant C3 is set in advance. The constant C3 may be set to a value greater than or equal to 1 or less than or equal to 1. The constant C3 is preferably set to a value in the range of 0.10 to 0.99. In the present embodiment, as an example, the constant C3 is set to 0.8.

If the speed command value ω_r is not greater than the speed target value ω_t multiplied by the constant C3 (S240: NO), the control circuit 30 ends the MTPA process shown in FIG. 8.

Meanwhile, if the speed command value ω_r is greater than the speed target value ω_t multiplied by the constant C3 (S240: YES), the control circuit 30 proceeds to S250 and transitions to the field-weakening mode M2. Then, the control circuit 30 ends the MTPA process shown in FIG. 8.

In this way, in the MTPA mode M1, the control circuit 30 sets the d-axis current command value Id_r to the MTPA current value Id_mtpa. Furthermore, the control circuit 30 transitions to the field-weakening mode M2 based on given conditions (that is, the conditions of S220, S230, and S240).

### [2-2-5. Field-Weakening Process]

The field-weakening process executed by the control circuit 30 will be described with reference to the flowchart in FIG. 9. The field-weakening process is a process of the control circuit 30 in the field-weakening mode M2.

First, in S300, the control circuit 30 adds a value obtained by multiplying a gain by (the q-axis current measured value Iq_m minus the q-axis current command value Iq_r) to the d-axis current command value Id_r. The gain at this time is, for example, 0.0008.

Alternatively, the control circuit 30 may convert a value obtained by multiplying a gain by (the measured speed value ω_m minus the speed command value ω_r) into a current value and add the current value to the d-axis current command value Id_r. The gain at this time is, for example, 0.00015.

Subsequently, in S310, the control circuit 30 determines whether the q-axis current measured value Iq_m is greater than or equal to a second current threshold value TH_I2.

The second current threshold value TH_I2 is a threshold value for determining whether the control circuit 30 transitions to the transition-in-progress mode M3. The second current threshold value TH_I2 is set to a value greater than the first current threshold value TH_I1. The second current threshold value TH_I2 is, for example, 30 amperes.

If the q-axis current measured value Iq_m is greater than or equal to the second current threshold value TH_I2 (S310: YES), the control circuit 30 proceeds to S320 and transitions to the transition-in-progress mode M3.

Subsequently, in S330, the control circuit 30 stores the current q-axis current measured value Iq_m as a q-axis current reference measured value Iq_hold.

Subsequently, in S340, the control circuit 30 stores the current d-axis current command value Id_r as a d-axis current reference command value Id_hold.

Then, the control circuit 30 ends the field-weakening process shown in FIG. 9.

Meanwhile, in S310, if the q-axis current measured value Iq_m is not greater than or equal to the second current threshold value TH_I2 (S310: NO), the control circuit 30 proceeds to S350 and determines whether the duty ratio Duty is less than a second duty threshold value TH_D2.

The second duty threshold value TH_D2 is a threshold value for determining whether the voltage output from the drive circuit 31 is saturated. The second duty threshold value TH_D2 is, for example, 95%.

If the duty ratio Duty is less than the second duty threshold value TH_D2 (S350: YES), the control circuit 30 proceeds to S320 and transitions to the transition-in-progress mode M3.

Meanwhile, if the duty ratio Duty is not less than the second duty threshold value TH_D2 (S350: NO), the control circuit 30 ends the field-weakening process shown in FIG. 9.

In this way, in the field-weakening mode M2, the control circuit 30 increases or decreases the d-axis current command value Id_r based on the difference between the q-axis current measured value Iq_m and the q-axis current command value Iq_r. Furthermore, the control circuit 30 transitions to the transition-in-progress mode M3 based on given conditions (that is, the conditions of S310 and S350).

[2-2-6. Transition in-Progress Process]

The transition-in-progress process executed by the control circuit 30 will be described with reference to the flowchart in FIG. 10. The transition-in-progress process is a process of the control circuit 30 in the transition-in-progress mode M3.

First, in S400, the control circuit 30 calculates the MTPA current value Id_mtpa. The method of calculating the MTPA current value Id_mtpa is the same as that in S200.

Subsequently, in S405, the control circuit 30 determines whether the q-axis current measured value Iq_m is greater than or equal to the second current threshold value TH_I2.

If the q-axis current measured value Iq_m is greater than or equal to the second current threshold value TH_I2 (S405: YES), the control circuit 30 proceeds to S410 and sets the d-axis current command value Id_r to the d-axis current reference command value Id_hold+(slope m×(the q-axis current measured value Iq_m−the q-axis current reference measured value Iq_hold)). The slope m represents a slope of a trajectory of the d-axis current command value Id_r in the d-q coordinate system in the transition-in-progress mode M3. Details will be described below. In the present embodiment, the slope m is set to zero. That is, the d-axis current command value Id_r is set to the d-axis current reference command value Id_hold.

Subsequently, in S415, the control circuit 30 determines whether the d-axis current command value Id_r is greater than the MTPA current value Id_mtpa.

If the d-axis current command value Id_r is not greater than the MTPA current value Id_mtpa (S415: NO), the control circuit 30 ends the transition-in-progress process shown in FIG. 10.

Meanwhile, if the d-axis current command value Id_r is greater than the MTPA current value Id_mtpa (S415: YES), the control circuit 30 proceeds to S420 and sets the d-axis current command value Id_r to the MTPA current value Id_mtpa.

Subsequently, in S425, the control circuit 30 transitions to the MTPA mode M1. Then, the control circuit 30 ends the transition-in-progress process shown in FIG. 10.

Meanwhile, if the q-axis current measured value Iq_m is not greater than or equal to the second current threshold value TH_I2 (S405: NO), the control circuit 30 proceeds to S430 and determines whether the duty ratio Duty is less than the second duty threshold value TH_D2.

If the duty ratio Duty is not less than the second duty threshold value TH_D2 (S430: NO), the control circuit 30 proceeds to S435 and adds a value obtained by multiplying a gain by (the q-axis current measured value Iq_m minus the q-axis current command value Iq_r) to the d-axis current command value Id_r. The process of S435 is the same as that of S300.

Subsequently, in S440, the control circuit 30 determines whether the q-axis current measured value Iq_m is less than the first current threshold value TH_I1.

If the q-axis current measured value Iq_m is not less than the first current threshold value TH_I1 (S440: NO), the control circuit 30 ends the transition-in-progress process shown in FIG. 10.

Meanwhile, if the q-axis current measured value Iq_m is less than the first current threshold value TH_I1 (S440: YES), the control circuit 30 proceeds to S445 and transitions to the field-weakening mode M2. Then, the control circuit 30 ends the transition-in-progress process shown in FIG. 10.

Meanwhile, if the duty ratio Duty is less than the second duty threshold value TH_D2 (S430: YES), the control circuit 30 proceeds to S450 and increments the d-axis current command value Id_r. The incremented value is, for example, 0.01 amperes.

Subsequently, in S455, the control circuit 30 determines whether the d-axis current command value Id_r is greater than the MTPA current value Id_mtpa.

If the d-axis current command value Id_r is not greater than the MTPA current value Id_mtpa (S455: NO), the control circuit 30 ends the transition-in-progress process shown in FIG. 10.

Meanwhile, if the d-axis current command value Id_r is greater than the MTPA current value Id_mtpa (S455: YES), the control circuit 30 proceeds to S460 and sets the d-axis current command value Id_r to the MTPA current value Id_mtpa.

Subsequently, in S465, the control circuit 30 transitions to the MTPA mode M1. Then, the control circuit 30 ends the transition-in-progress process shown in FIG. 10.

In this way, in the transition-in-progress mode M3, if the q-axis current measured value Iq_m is greater than or equal to the second current threshold value TH_I2 (S405: YES), the control circuit 30 sets the d-axis current command value Id_r based on the d-axis current reference command value Id_hold and the q-axis current measured value Iq_m. Furthermore, if the d-axis current command value Id_r is greater than the MTPA current value Id_mtpa (S415: YES), the control circuit 30 transitions to the MTPA mode M1.

Meanwhile, if the q-axis current measured value Iq_m is not greater than or equal to the second current threshold value TH_I2 (S405: NO), the control circuit 30 determines whether to transition to the MTPA mode M1 or to the field-weakening mode M2, or whether to continue the transition-in-progress mode M3, based on given conditions (that is, the conditions of S430, S440, and S455).

### [2-2-7. Regeneration Process]

The regeneration process executed by the control circuit 30 will be described with reference to the flowchart in FIG. 11. The regeneration process is a process of the control circuit 30 in the regeneration mode M4.

First, in S500, the control circuit 30 increments the d-axis current command value Id_r. The incremented value is, for example, 0.01 amperes.

Subsequently, in S510, the control circuit 30 determines whether the d-axis current command value Id_r is greater than zero.

If the d-axis current command value Id_r is greater than zero, the control circuit 30 proceeds to S520 and sets the d-axis current command value Id_r to zero. Then, the control circuit 30 proceeds to S530.

Meanwhile, if the d-axis current command value Id_r is not greater than zero, the control circuit 30 proceeds to S530.

Subsequently, in S530, the control circuit 30 determines whether the q-axis current command value Iq_r is greater than zero.

If the q-axis current command value Iq_r is greater than zero, the control circuit 30 proceeds to S540 and transitions to the MTPA mode M1. Then, the control circuit 30 ends the regeneration process shown in FIG. 11.

Meanwhile, if the q-axis current command value Iq_r is not greater than zero, the control circuit 30 ends the regeneration process shown in FIG. 11.

In this way, in the regeneration mode M4, the control circuit 30 increments the d-axis current command value Id_r until the d-axis current command value Id_r becomes greater than zero. If the d-axis current command value Id_r exceeds zero by the increment, the control circuit 30 sets the d-axis current command value Id_r to zero.

Furthermore, if the q-axis current command value Iq_r is greater than zero, the control circuit 30 transitions to the MTPA mode M1.

### [2-2-8. Trajectory of Current Vector in d-q Coordinate System]

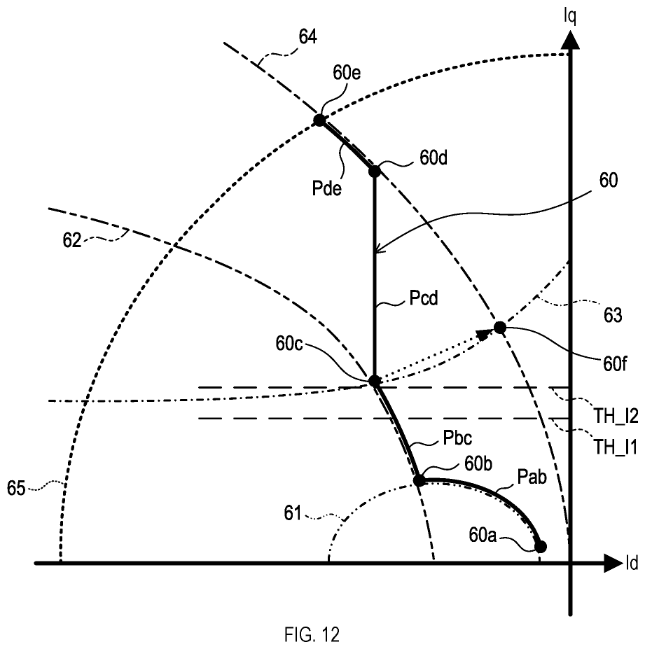

FIG. 12 shows a current trajectory 60, a back-EMF limit ellipse 61, an MTPF curve 62, a constant torque curve 63, an MTPA curve 64, and a current limit circle 65 in the d-q coordinate system. In the d-q coordinate system in FIG. 12, the d-axis is shown as an axis of the d-axis current Id, and the q-axis is shown as an axis of the q-axis current Iq.

The current trajectory 60 is a trajectory of the command value of the current vector I. In FIG. 12, the current trajectory 60 is represented by a solid line. However, the trajectory is omitted while the motor 6 is in the acceleration state.

When the motor 6 leaves the acceleration state and the control circuit 30 transitions from the MTPA mode M1 to the field-weakening mode M2, the current vector I is located at a point 60a.

When the torque of the motor 6 increases according to the pulling amount of the trigger 10, the magnitude of the current vector I increases. Hereinafter, the trajectory of the current vector I following the increase in torque will be described.

The current vector I transitions along the back-EMF limit ellipse 61 in a path Pab from the point 60a to an intersection 60b. The intersection 60b is an intersection of the back-EMF limit ellipse 61 and the MTPF curve 62.

The back-EMF limit ellipse 61 is represented by the following Equations 2 to 6.

$$[ Equation 2 ]$$

$${( {I}_{d} + \frac{{Ψ}_{a}}{{L}_{d}} )}^{2} + {( \frac{{L}_{q}}{{L}_{d}} {I}_{q} )}^{2} = {( \frac{{V}_{om}}{ω {L}_{d}} )}^{2} \approx {( \frac{{V}_{am} - {R}_{a} {I}_{a}}{ω {L}_{d}} )}^{2} \qquad ( 2 )$$

$$[ Equation 3 ]$$

$$\frac{{V}_{om}}{ω} = \sqrt{{( {L}_{d} {I}_{d} + {Ψ}_{a} )}^{2} + {( {L}_{q} {I}_{q} )}^{2}} \qquad ( 3 )$$

$$[ Equation 4 ]$$

$${V}_{o} = \sqrt{{( {V}_{a} - {R}_{a} {I}_{a} cos φ )}^{2} + {( {R}_{a} {I}_{a} sin φ )}^{2}} \approx {V}_{a} - {R}_{a} {I}_{a} \qquad ( 4 )$$

$$[ Equation 5 ]$$

$${V}_{a} = {R}_{a} [ \begin{matrix}{I}_{d} \\ {I}_{q}\end{matrix} ] + \frac{d}{dt} [ \begin{matrix}{L}_{d} {I}_{d} \\ {L}_{q} {I}_{q}\end{matrix} ] + ω [ \begin{matrix}- {L}_{q} {I}_{q} \\ {L}_{d} {I}_{d} + {Ψ}_{a}\end{matrix} ] \qquad ( 5 )$$

$$[ Equation 6 ]$$

$${V}_{om} \approx {V}_{am} - {R}_{a} {I}_{a} \qquad ( 6 )$$

In Equations 2 to 6, Vom is the maximum back-EMF amplitude [V]. ω is the rotational speed [rpm] of the motor 6 (that is, the rotor 19). Vam is the maximum voltage output amplitude [V]. Ra is a winding resistance [Ω]. Vo is a back-EMF [V]. Va is a voltage vector [V] according to the voltage equation of Equation 5. Ia is the current vector I [A]. φ is a current phase lag angle (in other words, a lag angle from the voltage phase) [rad]. The unit in parentheses represents an example of the unit.

MTPF is an abbreviation of Maximum Torque Per Flux. The MTPF curve 62 is a trajectory of the current vector I that maximizes the torque per unit magnetic flux of the motor 6. That is, the MTPF curve 62 is a set of points where maximum torque per unit magnetic flux is obtained in the d-q coordinate system.

The MTPF curve 62 is represented by the following Equations 7 to 8.

$$[ Equation 7 ]$$

$${I}_{d} = - \frac{{Ψ}_{a} + \frac{- {L}_{q} {Ψ}_{a} + \sqrt{{L}_{q}^{2} {Ψ}_{a}^{2} + 8 {( {L}_{q} - {L}_{d} )}^{2} {Ψ}_{o}^{2}}}{4 ( {L}_{q} - {L}_{d} )}}{{L}_{d}} \qquad ( 7 )$$

$$[ Equation 8 ]$$

$${I}_{q} = \frac{\sqrt{{Ψ}_{o}^{2} - {( {L}_{d} {I}_{d} + {Ψ}_{a} )}^{2}}}{{L}_{q}} \qquad ( 8 )$$

In equations 7 to 8, Ψ0 is the magnitude of the magnetic flux vector of the magnetic material in the rotor 19.

In the path Pab, the control circuit 30 performs control so that the current vector I is not set outside the back-EMF limit ellipse 61. For example, when the command value of the current vector I is set outside the back-EMF limit ellipse 61, the control circuit 30 decreases the d-axis current Id in the current vector I so that the current vector I is set inside the back-EMF limit ellipse 61 including the boundary of the back-EMF limit ellipse 61. The control in the path Pab is also referred to as a constant rotation control of the motor 6. In the path Pab, the control circuit 30 operates in the field-weakening mode M2.

The current vector I transitions along the MTPF curve 62 in a path Pbc from the intersection 60b to an intersection 60c. The intersection 60c is an intersection of the MTPF curve 62 and a given constant torque curve 63. In the path Pbc, the control circuit 30 performs so-called MTPF control. In the path Pbc, the control circuit 30 operates in the field-weakening mode M2.

The constant torque curve 63 is represented by the following Equation 9.

$$[ Equation 9 ]$$

$$T = {P}_{n} ( {Ψ}_{a} {I}_{q} + ( {L}_{d} - {L}_{q} ) {I}_{d} {I}_{q} ) \qquad ( 9 )$$

In Equation 9, torque T is a constant value. Pn is the number of pole pairs of the motor 6.

The current vector I transitions in a path Pcd from the intersection 60c to an intersection 60d so as to increase linearly corresponding to the slope m. When the slope m is equal to zero, the d-axis current Id in the current vector I is unchanged. The intersection 60d is an intersection of a straight line passing through the intersection 60c and the MTPA curve 64. The MTPA curve 64 is represented by the above-described Equation 1. That is, the MTPA curve 64 is a set of points in the d-q coordinate system where the maximum torque per unit current is obtained.

The slope m is set such that the path Pcd is located in a region on a positive side of the q-axis relative to the constant torque curve 63. The slope m may be set such that the path Pcd is located in a region on a positive side of the q-axis relative to the MTPF curve 62.

The q-axis component of the intersection 60c corresponds to the second current threshold value TH_I2. That is, in the path Pcd, the control circuit 30 operates in the transition-in-progress mode M3.

In the present embodiment, since the slope m is equal to zero, the path Pcd is a line segment parallel to the q-axis.

The current vector I transitions along the MTPA curve 64 in a path Pde from the intersection 60d to an intersection 60e. The intersection 60e is an intersection of the MTPA curve 64 and the current limit circle 65. In the path Pde, the control circuit 30 operates in the MTPA mode M1.

The current limit circle 65 is a circle representing an upper limit value of the magnitude of the current vector I. The current limit circle 65 is represented by the following Equation 10.

$$[ Equation 10 ]$$

$${I}_{am} = \sqrt{{( {I}_{d} )}^{2} + {( {I}_{q} )}^{2}} \qquad ( 10 )$$

In Equation 10, lam is a constant value representing the upper limit value of the magnitude of the current vector I. In the present embodiment, the bus current upper limit value Ib_limit is set for Iam.

### [2-2-9. Relationship Between Rotational Frequency and Torque]

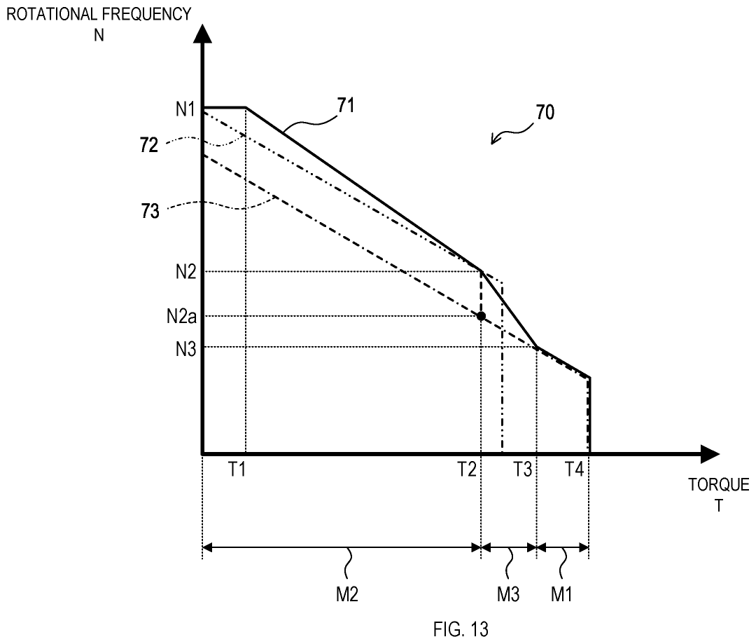

FIG. 13 shows a first N-T characteristic 71, a second N-T characteristic 72, and a third N-T characteristic 73 as an N-T characteristic 70 representing a relationship between rotational frequency N and torque T of the motor 6.

The first N-T characteristic 71 is an N-T characteristic when control in the present embodiment is performed on the motor 6.

The second N-T characteristic 72 is an N-T characteristic when normal trapezoidal control (also referred to as block commutation, six-step commutation, trapezoidal commutation, or rectangular wave control) is performed on the motor 6.

The third N-T characteristic 73 is an N-T characteristic when normal field-oriented control is performed on the motor 6.

The maximum rotational frequency of the normal trapezoidal control is greater than the maximum rotational frequency of the normal field-oriented control. The maximum torque of the normal trapezoidal control is smaller than the maximum torque of the normal field-oriented control.

Meanwhile, the maximum rotational frequency of the control of the present embodiment is greater than or equal to the maximum rotational frequency of the normal trapezoidal control. The maximum torque of the control of the present embodiment is greater than or equal to the maximum torque of the normal field-oriented control.

In the present embodiment, in a section where torque T of the motor 6 is less than a second torque constant T2, the control circuit 30 operates in the field-weakening mode M2. However, in a section where torque T is less than a first torque constant T1, the control circuit 30 performs constant rotation control of rotational frequency N1. At this time, the rotational frequency N in the first N-T characteristic 71 is greater than the rotational frequency N in each of the second N-T characteristic 72 and the third N-T characteristic 73.

In a section where torque T is more than or equal to the second torque constant T2 and the torque T is less than a third torque constant T3, the control circuit 30 operates in the transition-in-progress mode M3.

When torque T is equal to the second torque constant T2, the rotational frequency N in the first N-T characteristic 71 is substantially the same as a rotational frequency N2 in the second N-T characteristic 72.

When torque T is equal to the third torque constant T3, the rotational frequency N in the first N-T characteristic 71 is substantially the same as a rotational frequency N3 in the third N-T characteristic 73.

At this time, the control circuit 30 controls the current vector I so that a product of the rotational frequency N and the torque T, which is an output of the motor 6, does not change rapidly. For example, the control circuit 30 controls the current vector I so that the first N-T characteristic 71 changes along a straight line connecting (N2, T2) and (N3, T3). Alternatively, if N2×T2=N3×T3 is satisfied, the control circuit 30 controls the current vector I so as to change along an inverse proportional curve passing through (N2, T2) and (N3, T3).

In a section where the torque T is more than or equal to the third torque constant T3 and the torque T is less than or equal to a fourth torque constant T4, the control circuit 30 operates in the MTPA mode M1. The fourth torque constant T4 represents the maximum torque. In this section, the first N-T characteristic 71 and the third N-T characteristic 73 are substantially the same.

### [2-2-10. Relationship Between Rotational Frequency and Torque and Current]

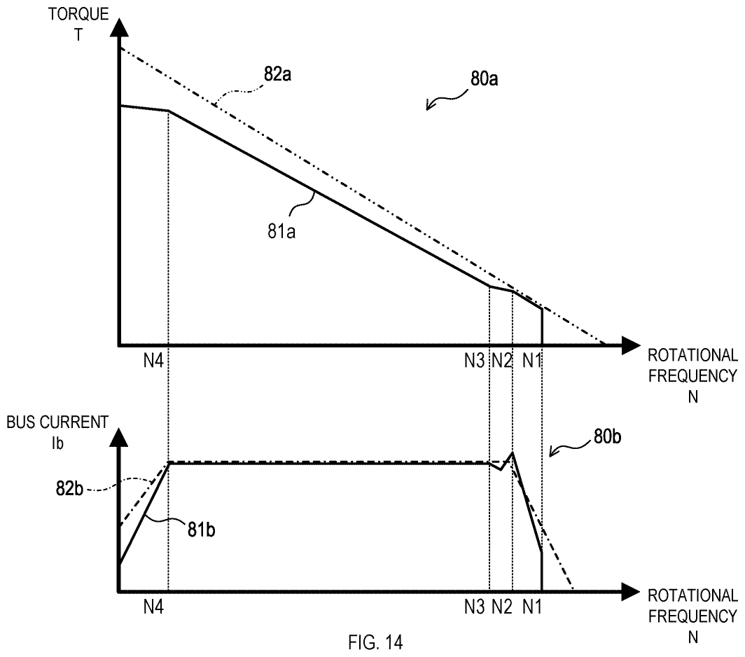

FIG. 14 shows a T-N characteristic 80a representing a relationship between the torque T and the rotational frequency N of the motor 6, and an I-N characteristic 80b representing a relationship between the bus current value Ib and the rotational frequency N of the motor 6.

The T-N characteristic 80a shows a first T-N characteristic 81a and a second T-N characteristic 82a.

The I-N characteristic 80b shows a first I-N characteristic 81b and a second I-N characteristic 82b.

The first T-N characteristic 81a is a T-N characteristic when the control in the present embodiment is performed on the motor 6.

The second T-N characteristic 82a is a trajectory of an upper limit value of the torque T (hereinafter also referred to as a “torque upper limit value”) in the motor 6. The torque T in the first T-N characteristic 81a is controlled so as not to exceed the torque upper limit value.

The first I-N characteristic 81b is a trajectory of the bus current value Ib that changes according to the rotational frequency N of the motor 6.

The second I-N characteristic 82b is a trajectory of the bus current upper limit value Ib_limit that changes according to the rotational frequency N of the motor 6.

The bus current Ib in the first I-N characteristic 81b is controlled so as not to exceed the bus current upper limit value Ib_limit in the second I-N characteristic 82b.

When the rotational frequency N is equal to N1, the constant rotation control is performed by the control circuit 30, and the torque T increases until it reaches the torque upper limit value. The bus current Ib increases as the torque T increases.

After the torque T reaches the torque upper limit value, the rotational frequency N decreases from N1. As the rotational frequency N decreases, the torque T and the bus current Ib further increase.

When the bus current Ib exceeds the bus current upper limit value Ib_limit, the bus current Ib is controlled so as to decrease to be less than or equal to the bus current upper limit value Ib_limit. At this time, the rotational frequency N is N2. That is, as the rotational frequency N decreases from N2, the bus current Ib decreases. As the rotational frequency N decreases, the torque T increases; however, an increase amount of the torque T is smaller than that in the section where the rotational frequency N is greater than N2.

When the bus current Ib falls below the bus current upper limit value Ib_limit, the bus current Ib is controlled so as to increase up to the bus current upper limit value Ib_limit. When the bus current Ib is equal to the bus current upper limit value Ib_limit, the rotational frequency N is equal to N3. That is, as the rotational frequency N decreases from N2 to N3, the bus current Ib is controlled to be equal to the bus current upper limit value Ib_limit. As the rotational frequency N decreases, the torque T increases.

In a section where the rotational frequency N is from N3 to N4, the bus current Ib and the bus current upper limit value Ib_limit are constant values. As the rotational frequency N decreases, the torque T increases.

In a section where the rotational frequency N is less than N4, the bus current Ib and the bus current upper limit value Ib_limit monotonically decrease. A decrease amount of the bus current Ib is greater than a decrease amount of the bus current upper limit value Ib_limit. As the rotational frequency N decreases, the torque T increases, but the increase amount of the torque T is smaller than that in a section where the rotational frequency N is greater than N4.

In this way, the bus current value Ib is controlled so as not to exceed the bus current upper limit value Ib_limit. The increase amount of the torque T, which is according to the rotational frequency N, is affected by the increase or decrease of the bus current Ib.

### 2-3. Effects

According to the embodiment described above, the following effects can be obtained.

(2a) The control circuit 30 operates so as to pass through the transition-in-progress mode M3 when transitioning from the field-weakening mode M2 to the MTPA mode M1. As shown in FIG. 12, in the d-q coordinate system, the current vector I transitions so as to increase linearly corresponding to the slope m in the path Pcd where the control circuit 30 operates in the transition-in-progress mode M3. The slope m is set such that the path Pcd is located in a region on a positive side of the q-axis relative to the constant torque curve 63. The slope m may be set such that the path Pcd is located in a region on a positive side of the q-axis relative to the MTPF curve 62.

That is, when the q-axis current measured value Iq_m is greater than or equal to the second current threshold value TH_I2, in other words, when the q-axis current measured value Iq_m is included in a region on a positive side of the q-axis relative to an intersection 60c between the MTPF curve 62 and the constant torque curve 63, the current vector I is set in a region on a positive side of the q-axis relative to both the MTPF curve 62 and the constant torque curve 63.

Suppose that the control circuit 30 transitions from the field-weakening mode M2 to the MTPA mode M1 without passing through the transition-in-progress mode M3. In this case, as shown in FIG. 12, the current vector I in the d-q coordinate system transitions from the intersection 60c on the MTPF curve 62 to an intersection 60f on the MTPA curve 64. The intersection 60f is an intersection of the constant torque curve 63 and the MTPA curve 64.

At this time, as shown in FIG. 13, the N-T characteristic 70 exhibits a rapid decrease in rotational frequency N from N2 to N2a while the torque T remains at T2. The rotational frequency N2a is the rotational frequency N when torque T is equal to T2 in the third N-T characteristic 73. When the rotational frequency N rapidly decreases while the torque T remains constant, the product of the rotational frequency N and the torque T, which is the output of the motor 6, rapidly changes, so that the stability of the operation of the motor 6 decreases.

In contrast, according to the process of the present embodiment, when transitioning from the field-weakening mode M2 to the MTPA mode M1, in other words, when switching from the field-weakening control to the normal field-oriented control, the control circuit 30 passes through the transition-in-progress mode M3 that inhibits a rapid change in the output of the motor 6. Since the path Pcd in the d-q coordinate system corresponding to the transition-in-progress mode M3 is included in the region on the positive side of the q-axis relative to both the MTPF curve 62 and the constant torque curve 63, it is possible to transition to the MTPA mode M1 without rapidly decreasing the torque T. Accordingly, the stability of the output of the motor 6 can be improved.

(2b) In the transition-in-progress mode M3, if the d-axis current command value Id_r is greater than the MTPA current value Id_mtpa (S415: YES), the control circuit 30 sets the d-axis current command value Id_r to the MTPA current value Id_mtpa (S420), and transitions to the MTPA mode M1 (S425). In other words, in the d-q coordinate system in FIG. 12, the current vector I transitions along the path Pcd and the path Pde.

According to such a process, the control circuit 30 can control the current vector I along the MTPA curve 64 as the q-axis current Iq increases.

(2c) When transitioning from the field-weakening mode M2 to the transition-in-progress mode M3, the control circuit 30 stores the current q-axis current measured value Iq_m as the q-axis current reference measured value Iq_hold (S330) and stores the current d-axis current command value Id_r as the d-axis current reference command value Id_hold (S340).

In the transition-in-progress mode M3, if the q-axis current measured value Iq_m is greater than or equal to the second current threshold value TH_I2 (S405: YES), the control circuit 30 sets the d-axis current command value Id_r based on the q-axis current command value Iq_r and the d-axis current command value Id_r (S410).

According to such a process, the d-axis current command value Id_r in the transition-in-progress mode M3 can be set using the q-axis current measured value Iq_m and the d-axis current command value Id_r at the time of transitioning from the field-weakening mode M2 to the transition-in-progress mode M3. Therefore, a rapid change in the current vector I can be inhibited.

(2d) The control circuit 30 transitions between two or more modes based on the q-axis current measured value Iq_m. That is, on condition that the q-axis current measured value Iq_m is less than the first current threshold value TH_I1 (S230: YES), the control circuit 30 transitions from the MTPA mode M1 to the field-weakening mode M2 (S250). On condition that the q-axis current measured value Iq_m is greater than or equal to the second current threshold value TH_I2 (S310: YES), the control circuit 30 transitions from the field-weakening mode M2 to the transition-in-progress mode M3 (S320). Depending on whether the q-axis current measured value Iq_m is greater than or equal to the second current threshold value TH_I2 (S405), the control circuit 30 can transition from the transition-in-progress mode M3 to the MTPA mode M1 or the field-weakening mode M2.

The q-axis current measured value Iq_m is calculated through the command unit 43 and the speed control unit 44 based on the second trigger signal TR2 corresponding to the pulling amount of the trigger 10 manually operated by the user.

According to such a process, the operation mode of the control circuit 30 can be switched according to the pulling amount of the trigger 10 manually operated by the user. Accordingly, the control circuit 30 can be operated in an optimal operation mode corresponding to the pulling amount of the trigger 10.

(2e) In the path Pab in the d-q coordinate system shown in FIG. 12, the control circuit 30 performs control such that the current vector I is not set outside the back-EMF limit ellipse 61. The control in the path Pab is the constant rotation control of the motor 6. The control circuit 30 performs the constant rotation control based on the above-described Equations 2 to 6. That is, the control circuit 30 performs the constant rotation control based on both the q-axis current Iq and the d-axis current Id.

According to such a process, the constant rotation control can be achieved by setting an appropriate current vector I based on not only the q-axis current Iq but also both the q-axis current Iq and the d-axis current Id.

(2f) When the bus current detection signal Sib, the bus current upper limit value Ib_limit, and the d-axis current measured value Id_m are input by the limit value calculation unit 46, the control circuit 30 calculates the d-axis current limit value Id_limit. Specifically, the d-axis current limit value Id_limit is calculated based on a difference between the bus current value Ib indicated by the bus current detection signal Sib and the bus current upper limit value Ib_limit.

According to such a configuration, the d-axis current command value Id_r can be dynamically controlled based on the bus current value Ib so as not to exceed the bus current upper limit value Ib_limit.

(2g) In the transition-in-progress mode M3, on condition that the q-axis current measured value Iq_m is greater than or equal to the second current threshold value TH_I2 (S405: YES), the control circuit 30 transitions to the MTPA mode M1 (S425).

Meanwhile, in the transition-in-progress mode M3, on condition that the q-axis current measured value Iq_m is less than the first current threshold value TH_I1 (S440: YES), the control circuit 30 transitions to the field-weakening mode M2 (S445). The first current threshold value TH_I1 is set to a value smaller than the second current threshold value TH_I2.

According to such a process, immediately after transitioning from the field-weakening mode M2 to the transition-in-progress mode M3, even if the q-axis current measured value Iq_m falls below the second current threshold value TH_I2, transition of the control circuit 30 from the transition-in-progress mode M3 to the field-weakening mode M2 is inhibited as long as the q-axis current measured value Iq_m is greater than or equal to the first current threshold value TH_I1. Therefore, even when the q-axis current measured value Iq_m changes in the vicinity of the second current threshold value TH_I2, it is possible to inhibit the transition between the transition-in-progress mode M3 and the field-weakening mode M2 from being repeated more than necessary.

(2h) As shown in FIG. 13, in the section where torque T is less than the second torque constant T2 in the N-T characteristic 70, the control circuit 30 operates in the field-weakening mode M2. In the field-weakening mode M2, the control circuit 30 performs so-called field-weakening control.

According to such a process, the rotational frequency N in the present embodiment is greater than the rotational frequency N in each of the normal trapezoidal control and the normal field-oriented control. Therefore, the maximum rotational frequency of the motor 6 can be improved.

### 2-4. Correspondence Between Terms

In the above embodiment, the control circuit 30 corresponds to an example of a control circuit, the current vector I corresponds to an example of a current, and the q-axis current command value Iq_r and the d-axis current command value Id_r correspond to an example of a current command value. The MTPF curve 62 corresponds to an example of a maximum flux efficiency curve, and the MTPA curve 64 corresponds to an example of a maximum current efficiency curve. The MTPA mode M1 corresponds to an example of a first mode, the field-weakening mode M2 corresponds to an example of a second mode, and the transition-in-progress mode M3 corresponds to an example of a third mode. The second current threshold value TH_I2 corresponds to an example of a given threshold value, the q-axis current reference measured value Iq_hold corresponds to an example of a reference measured value, and the d-axis current reference command value Id_hold corresponds to an example of a reference command value. The bus current Ib corresponds to an example of a power supply current, the bus current upper limit value Ib_limit corresponds to an example of an upper limit value of the power supply current, and the d-axis current limit value Id_limit corresponds to an example of an upper limit value of a d-axis component of the current command value. The first to third coils 20a, 20b, 20c correspond to a configuration that generates a magnetic field when a current flows therethrough.

### 3. Second Embodiment

### 3-1. Configuration

The basic configuration of an electric work machine 1 in the second embodiment is the same as that of the electric work machine 1 in the first embodiment. Therefore, differences between the second embodiment and the first embodiment will be described below. The same reference numerals as those in the first embodiment denote the same configurations, and the preceding description is referred to.

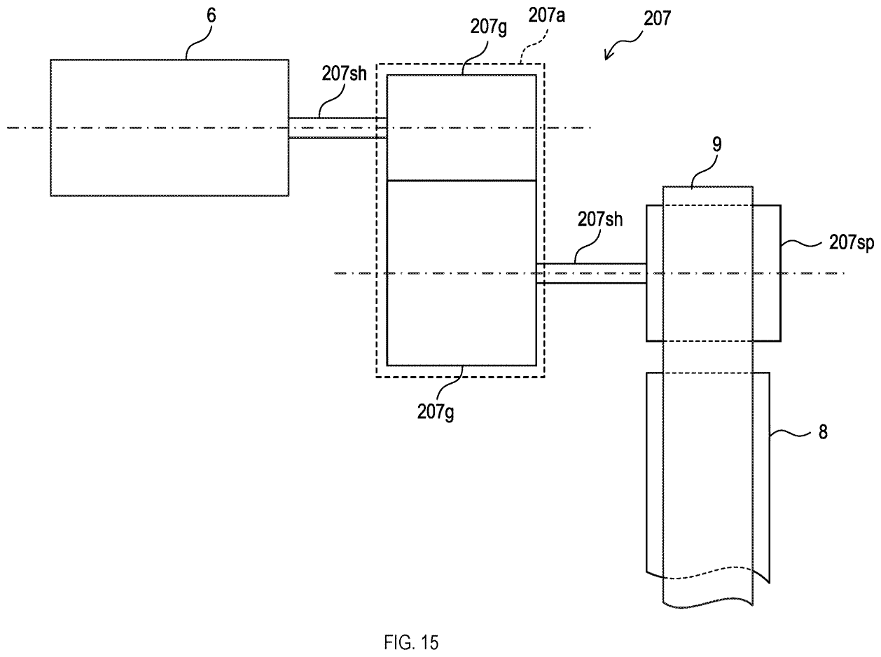

The electric work machine 1 in the second embodiment includes a drive transmission 207 as shown in FIG. 15 instead of the drive transmission 7 of the first embodiment described above.

The drive transmission 207 is directly or indirectly coupled to the motor 6 (specifically, the rotor 19; see FIG. 2). The drive transmission 207 includes two or more shaft members 207sh, a gear mechanism 207a that reduces the speed of rotation of the motor 6 transmitted to the saw chain 9, and a sprocket 207sp configured so that the saw chain 9 is attached thereto.

Specifically, the gear mechanism 207a is coupled to the motor 6 via the shaft members 207sh. The sprocket 207sp is coupled to the gear mechanism 207a via the shaft members 207sh.

The drive transmission 207 transmits the rotation of the motor 6 (specifically, the rotation of the rotor 19) to the saw chain 9 via the shaft members 207sh, the gear mechanism 207a, and the sprocket 207sp and drives the saw chain 9 by the rotation. When the motor 6 is driven, the saw chain 9 moves along the peripheral portion of the guide bar 8. Thus, the saw chain 9 can perform work on a target object. Specifically, the saw chain 9 can cut workpieces such as wood, metal, and resin.

The gear mechanism 207a includes two gears 207g having different numbers of teeth. The gear mechanism 207a reduces the rotational speed of the motor 6 transmitted to the saw chain 9 by the difference in the number of teeth of the two gears 207g. The degree of reduction of the rotational speed achieved by the gear mechanism 207a depends on the gear ratio of the two gears 207g. For example, when the gear ratio is 1/2, the rotational speed of the motor 6 transmitted to the saw chain 9 is reduced to ½ of the rotational speed of the motor 6.

Hereinafter, examples of specific set values set for the second embodiment A and the second embodiment B, in which maximum outputs of the motor 6 are different from each other, will be described.

### [3-1-1. Set Values of Second Embodiment A]

The second embodiment A is an example in which the maximum output of the motor 6 is about 2 to 3 [kW]. For example, the output of the motor 6 may be in the range of 1.7 [kW] to 2.7 [kW].

### <Gear Ratio>

The gear ratio is set to a value within a given range.

As an example of the second embodiment A, the gear ratio may be in the range of 1/2.8 to 1/1.6 or may be in the range of 1/2.4 to 1/2.0. At this time, the maximum rotational frequency of the motor 6 may be greater than or equal to 30000 [rpm].

For example, among the two gears 207g, when the number of teeth of the gear 207g coupled to the motor 6 is 13 and the number of teeth of the gear 207g coupled to the sprocket 207sp is 27, the gear ratio is 13/27≈1/2.08. This gear ratio is within the range described above.

As another example, the gear ratio may be in the range of 1/3.73 to 1/2.13 or may be in the range of 1/3.20 to 1/2.67. At this time, the maximum rotational frequency of the motor 6 may be greater than or equal to 40000 [rpm]. That is, the gear ratio may be in the range from 1/3.73 to 1/1.60.

### <Diameter, Stack Length, Volume>

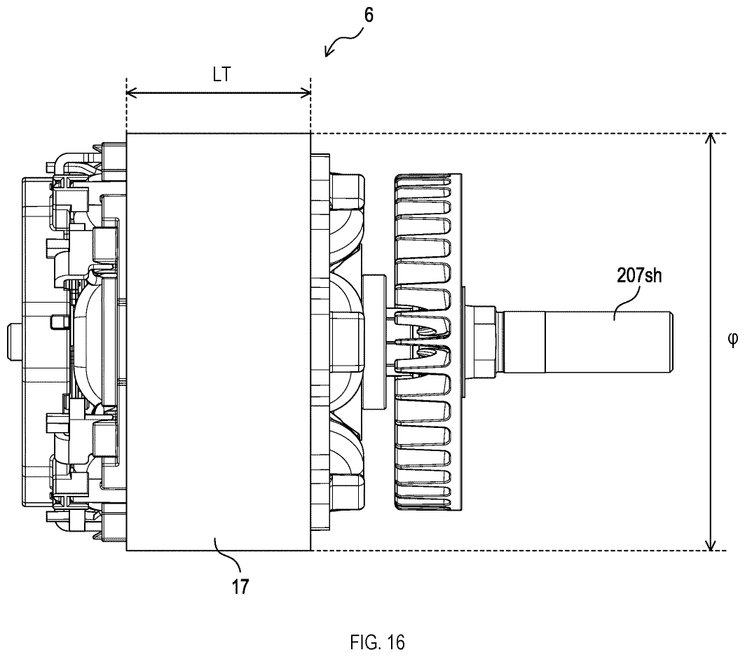

As shown in FIG. 16, a motor diameter φ which is the diameter of the motor 6, a stack length LT of the stator 17, and the volume of the motor 6 are set to values within given ranges.

As an example, the motor diameter φ may be in the range of 40 [mm] to 80 [mm], may be in the range of 46 [mm] to 72 [mm], or may be in the range of 52 [mm] to 68 [mm].

The stack length LT may be in the range of 12 [mm] to 40 [mm], may be in the range of 16 [mm] to 35 [mm], or may be in the range of 20 [mm] to 30 [mm].

The volume of the motor 6 may be in the range of 15000 [mm\hat{ }3] to 202000 [mm\hat{ }3], may be in the range of 50000 [mm\hat{ }3] to 150000 [mm\hat{ }3], or may be in the range of 80000 [mm\hat{ }3] to 120000 [mm\hat{ }3].

### <Mass>

The mass of the main body of the electric work machine 1 may be configured to be a value within a given range. The mass of the main body of the electric work machine 1 is a mass excluding the battery pack 15 (including the battery 15a), the saw chain 9, and oil for the saw chain 9 from the electric work machine 1.

As an example of the second embodiment A, the mass of the main body of the electric work machine 1 may be configured to be in the range of 2.5 [kg] to 5.0 [kg], may be configured to be in the range of 3.0 [kg] to 4.5 [kg], or may be configured to be in the range of 3.2 [kg] to 4.0 [kg].

### [3-1-2. Set Values of Second Embodiment B]

The second embodiment B is an example in which the maximum output of the motor 6 is about 3 to 4 [kW]. For example, the output of the motor 6 may be within the range of 3.0 [kW] to 4.0 [kW].

In the second embodiment B, as in the second embodiment A, the gear ratio, diameter, stack length, volume, mass, and the like may be set to fall within given ranges.

### <Gear Ratio>

As an example of the second embodiment B, the gear ratio may be in the range of 1/3.0 to 1/1.8 or may be in the range of 1/2.6 to 1/2.2. At this time, the maximum rotational frequency of the motor 6 may be greater than or equal to 30000 [rpm].

As another example, the gear ratio may be in the range of 1/4.00 to 1/2.40 or may be in the range of 1/3.47 to 1/2.93. At this time, the maximum rotational frequency of the motor 6 may be greater than or equal to 40000 [rpm]. That is, the gear ratio may be in the range from 1/4.00 to 1/1.80.

### <Diameter, Stack Length, Volume>

As an example of the second embodiment B, the motor diameter φ shown in FIG. 16 may be in the range of 50 [mm] to 90 [mm], may be in the range of 65 [mm] to 100 [mm], or may be in the range of 75 [mm] to 120 [mm]. That is, the motor diameter φ may be in the range of 50 [mm] to 120 [mm].

The stack length LT may be in the range of 10 [mm] to 50 [mm], may be in the range of 15 [mm] to 40 [mm], or may be in the range of 20 [mm] to 30 [mm].

The volume of the motor 6 may be in the range of 85000 [mm\hat{ }3] to 115600 [mm\hat{ }3], may be in the range of 95000 [mm\hat{ }3] to 130000 [mm\hat{ }3], or may be in the range of 107000 [mm\hat{ }3] to 145000 [mm\hat{ }3].

### <Mass>

As an example of the second embodiment B, the mass of the main body of the electric work machine 1 may be in the range of 5.0 [kg] to 7.0 [kg], may be in the range of 4.0 [kg] to 6.5 [kg], or may be in the range of 4.5 [kg] to 6.0 [kg].

### 3-2. Relationship of Rotational Frequency, Output, Current, and Voltage to Torque

### [3-2-1. Characteristics of Second Embodiment A]

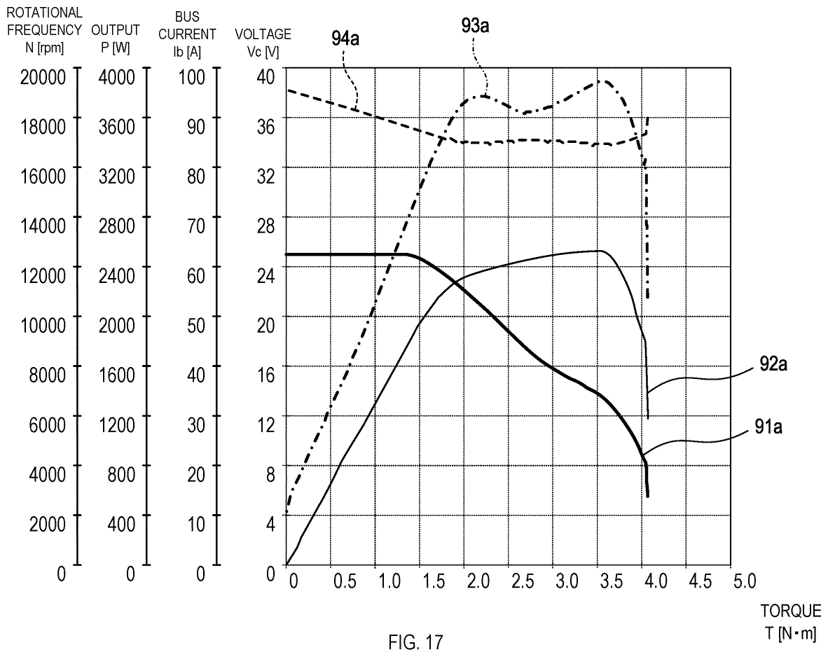

FIG. 17 shows an actual N-T characteristic 91a, an actual P-T characteristic 92a, an actual I-T characteristic 93a, and an actual V-T characteristic 94a when the control in the present embodiment is performed on the motor 6.

The actual N-T characteristic 91a represents an example of measured values of the relationship between rotational frequency N [rpm] and torque T [N·m] of the motor 6.

The actual P-T characteristic 92a represents an example of measured values of the relationship between motor output P [W], which is the output of the motor 6, and torque T [N·m].

The actual I-T characteristic 93a represents an example of measured values of the relationship between the bus current value Ib [A] and the torque T [N·m]. The actual V-T characteristic 94a represents an example of measured values of the relationship between the power supply voltage Vc [V] and the torque T [N·m].

As shown in FIG. 17, the control circuit 30 controls the motor 6 such that the maximum torque (i.e., the maximum value of the torque T) of the motor 6 is greater than or equal to 4.0 [N·m].

The control circuit 30 controls the motor 6 such that the maximum rotational frequency (i.e., the maximum value of the rotational frequency N) of the motor 6 is greater than or equal to 10000 [rpm]. Preferably, the control circuit 30 controls the motor 6 such that the maximum rotational frequency of the motor 6 is greater than or equal to 11000 [rpm]. More preferably, the control circuit 30 controls the motor 6 such that the maximum rotational frequency of the motor 6 is greater than or equal to 12000 [rpm].

The control circuit 30 controls the motor 6 such that the torque T is in the range of 1.5 [N·m] to 4.0 [N·m] and the motor output P is in the range of 1.7 [kW] to 2.6 [kW].

When the motor 6 exhibits the characteristics as shown in FIG. 17, the chain speed [m/s] during driving of the saw chain 9 is greater than or equal to 20 [m/s]. Preferably, the chain speed [m/s] during driving of the saw chain 9 is greater than or equal to 24 [m/s]. That is, the control circuit 30 controls the motor 6 such that the chain speed [m/s] during driving of the saw chain 9 is greater than or equal to 20 [m/s]. Preferably, the control circuit 30 controls the motor 6 such that the chain speed [m/s] during driving of the saw chain 9 is greater than or equal to 24 [m/s].

### [3-2-2. Characteristics of Second Embodiment B]

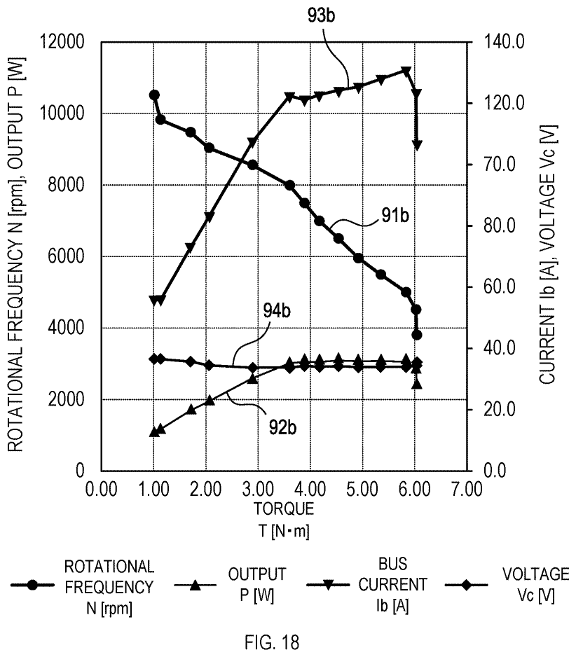

FIG. 18 shows an actual N-T characteristic 91b, an actual P-T characteristic 92b, an actual I-T characteristic 93b, and an actual V-T characteristic 94b when the control in the present embodiment is performed on the motor 6. The characteristics shown in FIG. 18 are characteristics of a different type of motor 6 from the motor 6 having the characteristics shown in FIG. 17.

The actual N-T characteristic 91b represents an example of measured values of the relationship between the rotational frequency N [rpm] and the torque T [N·m] of the motor 6.

The actual P-T characteristic 92b represents an example of measured values of the relationship between the motor output P [W] and the torque T [N·m].

The actual I-T characteristic 93b represents an example of measured values of the relationship between the bus current value Ib [A] and the torque T [N·m]. The actual V-T characteristic 94b represents an example of measured values of the relationship between the power supply voltage Vc [V] and the torque T [N·m].

As shown in FIG. 18, the control circuit 30 controls the motor 6 such that the maximum torque (i.e., the maximum value of the torque T) of the motor 6 is greater than or equal to 6.0 [N·m].

The control circuit 30 controls the motor 6 such that the maximum rotational frequency (i.e., the maximum value of rotational frequency N) of the motor 6 is greater than or equal to 11000 [rpm]. Preferably, the control circuit 30 controls the motor 6 such that the maximum rotational frequency of the motor 6 is greater than or equal to 12000 [rpm].

The control circuit 30 controls the motor 6 such that the torque T is in the range of 3.5 [N·m] to 6.0 [N·m] and the motor output P is in the range of 3.0 [kW] to 4.0 [kW].

When the motor 6 exhibits the characteristics as shown in FIG. 18, the chain speed [m/s] during driving of the saw chain 9 is greater than or equal to 20 [m/s]. Preferably, the chain speed [m/s] during driving of the saw chain 9 is greater than or equal to 24 [m/s]. That is, the control circuit 30 controls the motor 6 such that the chain speed [m/s] during driving of the saw chain 9 is greater than or equal to 20 [m/s]. Preferably, the control circuit 30 controls the motor 6 such that the chain speed [m/s] during driving of the saw chain 9 is greater than or equal to 24 [m/s].

### 3-3. Effects

According to the second embodiment described above in detail, the same effects as those of (2a) to (2h) of the first embodiment are obtained. In addition, according to the second embodiment, the following effects can be obtained.

(3a) The control circuit 30 controls the motor 6 by performing the field-oriented control and the field-weakening control. The electric work machine 1 is in the form of an electric chainsaw.

According to such a configuration, it is possible to realize a chainsaw that can output high torque T and can increase the rotational frequency N of the motor 6 when the torque T is low.

(3b) The drive transmission 207 includes the gear mechanism 207a. The gear mechanism 207a reduces the rotational speed of the motor 6 transmitted to the saw chain 9 by the gear ratio of the two gears 207g.

According to such a configuration, the torque T of the motor 6 is increased by reducing the rotational speed transmitted from the motor 6 to the saw chain 9 without largely fluctuating the current flowing through the motor 6. Therefore, power consumption during work can be reduced while ensuring high torque T.

### 4. Third Embodiment

### 4-1. Configuration

The basic configuration of an electric work machine 301 in a third embodiment is the same as that of the electric work machine 1 of the first embodiment. Therefore, differences between the third embodiment and the first embodiment will be described below. The same reference numerals as those in the first embodiment denote the same configurations, and the preceding description is referred to.

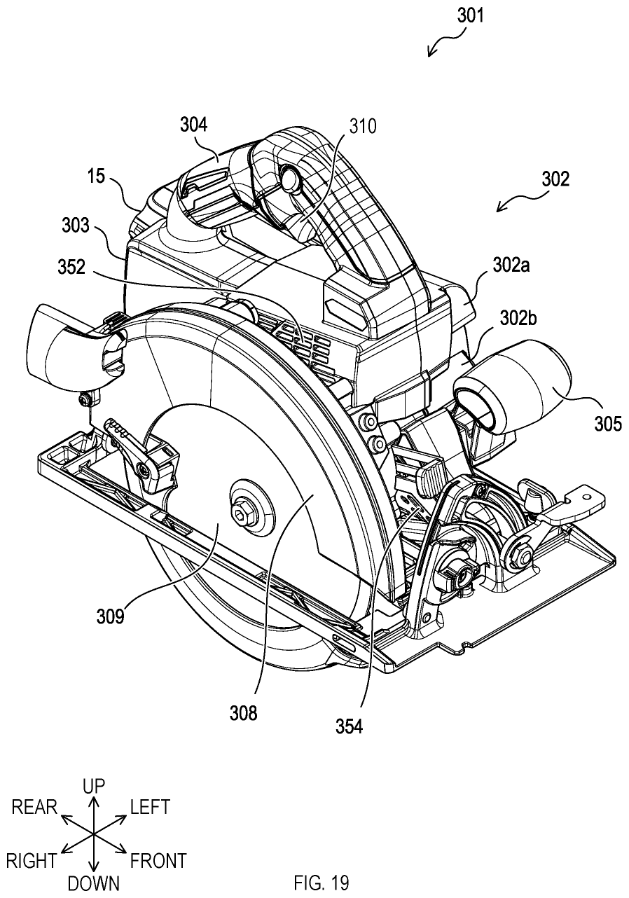

As shown in FIG. 19 to FIG. 23, the electric work machine 301 of the third embodiment is in the form of an electric circular saw (hereinafter also simply referred to as a circular saw) as another example of the electric work machine 1 of the first embodiment. The circular saw is used as a portable cutting machine. The circular saw may be, for example, a slide circular saw, a plunge circular saw, or the like.

The electric work machine 301 includes a housing 302 as shown in FIG. 19 to FIG. 23 instead of the housing 2 of the first embodiment described above.

The housing 302 includes, at its rear part, a battery attachment part 303. The battery attachment part 303 is the same as the battery attachment part 3 of the first embodiment described above.

The electric work machine 301 includes a handle 304 on an upper part of the housing 302. The handle 304 is gripped by a user of the electric work machine 301.

A trigger 310 is provided on a lower surface of the handle 304. The trigger 310 is the same as the trigger 10 of the first embodiment described above.

The housing 302 includes a controller housing 302a and a motor housing 302b. The controller housing 302a is located below the handle 304. The motor housing 302b is located below the controller housing 302a.

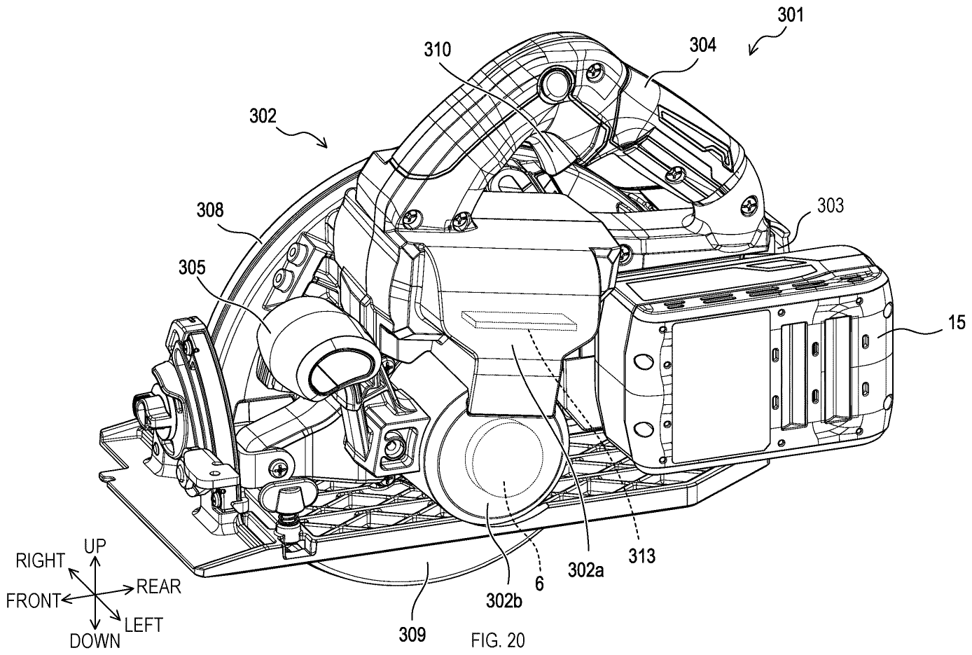

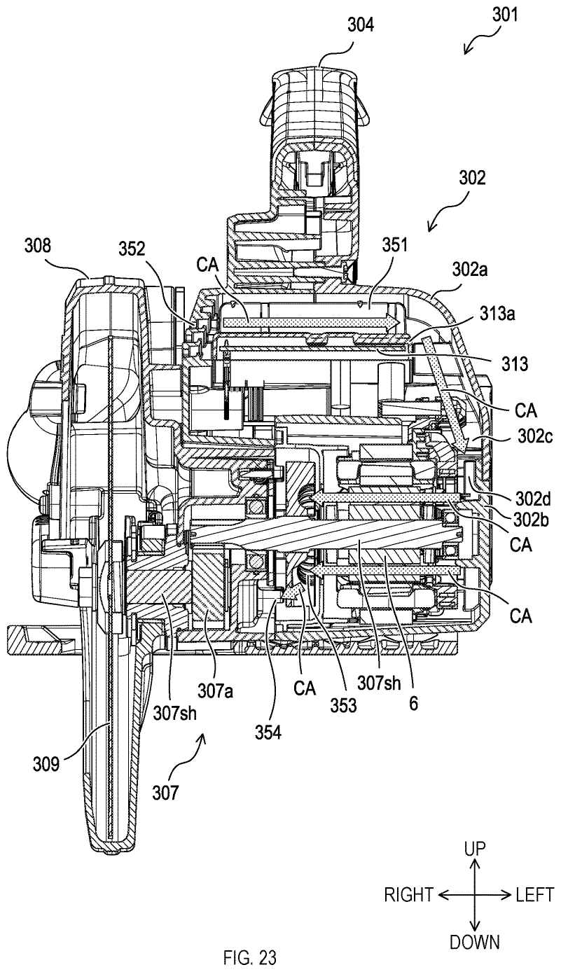

As shown in FIG. 20 and FIG. 23, the controller housing 302a houses a controller 313 therein. The basic configuration of the controller 313 is the same as that of the controller 13 of the first embodiment described above. That is, the controller 313 includes a control circuit 30 similar to that of the first embodiment described above.

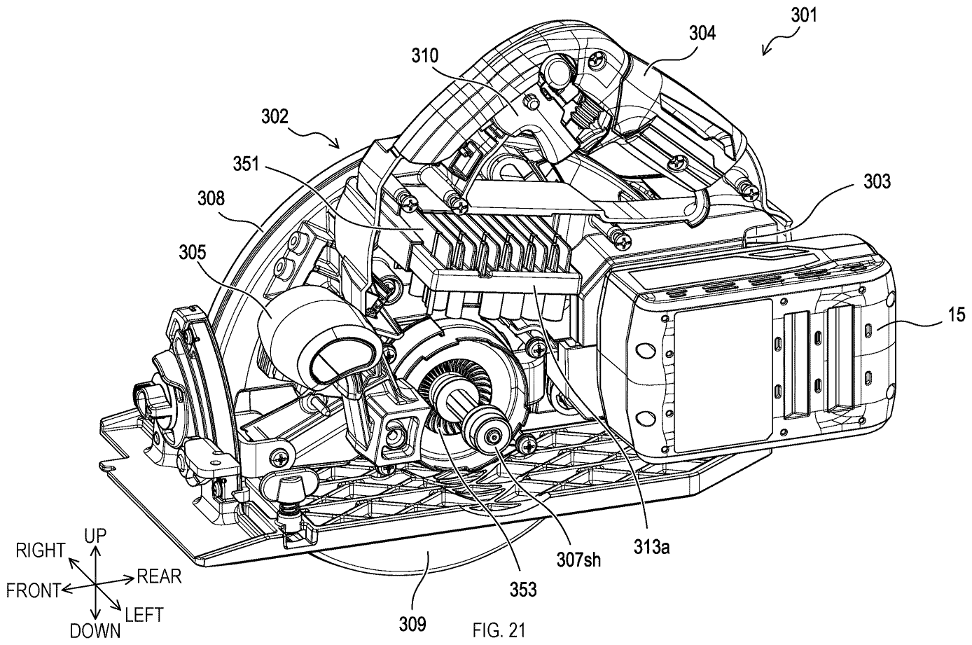

The controller 313 is housed inside a case 313a. As shown in FIG. 21 and FIG. 23, a heat sink 351 is provided on an upper surface of the case 313a. The heat sink 351 is provided with two or more fins. Each of the fins projects upward from the upper surface of the case 313a to the same height as the other fins. Each of the fins is provided so as to extend in a left-right direction. Each of the fins is arranged at substantially equal intervals parallel to a front-rear direction.

As shown in FIG. 20 and FIG. 23, the motor housing 302b houses the motor 6 and a drive transmission 307 therein.

The basic configuration of the drive transmission 307 is the same as that of the drive transmission 7 of the first embodiment or the second embodiment described above. As shown in FIG. 23, the drive transmission 307 is directly or indirectly coupled to the motor 6 (specifically, the rotor 19). Instead of the saw chain 9 of the first embodiment described above, the drive transmission 307 is directly or indirectly coupled to a disk-shaped blade tool 309. The drive transmission 307 includes a gear mechanism 307a that reduces the rotational speed of the motor 6 transmitted to the blade tool 309 and two or more shaft members 307sh configured so that the motor 6 or the blade tool 309 is attached thereto. The basic configurations of the gear mechanism 307a and the shaft members 307sh are the same as those of the gear mechanism 207a and the shaft members 207sh of the second embodiment described above, respectively. The drive transmission 307 transmits the rotation of the motor 6 (specifically, the rotation of the rotor 19) to the blade tool 309 via the gear mechanism 307a and the shaft members 307sh and drives the blade tool 309 by the rotation.

As shown in FIG. 19 and FIG. 20, the electric work machine 301 includes a sub-grip 305 at the front part of the motor housing 302b. The sub-grip 305 is gripped by the user. The user can use the electric work machine 301 while, for example, gripping the handle 304 with one hand (e.g., right hand) and gripping the sub-grip 305 with the other hand (e.g., left hand). The handle 304 is made of, for example, resin. The sub-grip 305 is made of, for example, resin.

The electric work machine 301 includes a blade case 308 at a right part of the housing 302. The blade case 308 is provided so as to cover approximately an upper half of the blade tool 309. The thickness direction of the blade tool 309 is parallel to the left-right direction.

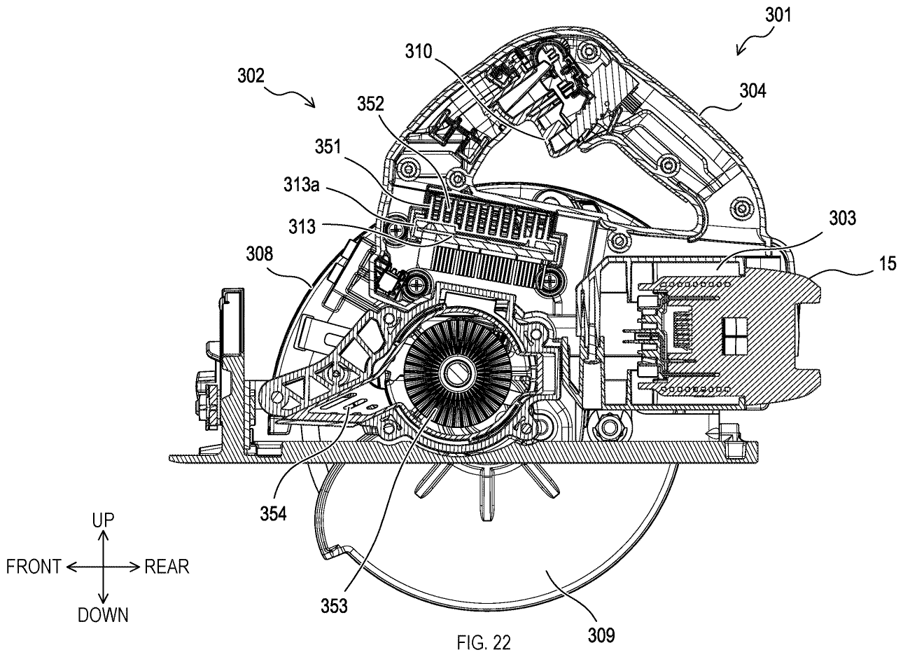

As shown in FIG. 19, FIG. 22, and FIG. 23, the controller housing 302a includes an intake port 352 at its right part. The intake port 352 is provided to face a left surface of the blade case 308. The intake port 352 has two or more slits extending in the front-rear direction. The space inside the controller housing 302a communicates with the outside of the electric work machine 301 through the slits of the intake port 352.

The motor housing 302b includes an exhaust port 354 at its right part. The exhaust port 354 is provided to face the left surface of the blade case 308. The exhaust port 354 has two or more slits extending in the front-rear direction. The space inside the motor housing 302b communicates with the outside of the electric work machine 301 through the slits of the exhaust port 354.

As shown in FIG. 23, the controller housing 302a includes a first opening 302c in a portion near the motor housing 302b. The motor housing 302b includes a second opening 302d in a portion near the controller housing 302a. The internal space of the motor housing 302b communicates with the internal space of the controller housing 302a through these first and second openings 302c and 302d.

As shown in FIG. 23, a cooling fan 353 is attached to one of the shaft members 307sh coupled to the motor 6. The cooling fan 353 rotates following the rotation of the motor 6. When the motor 6 is started and the cooling fan 353 rotates, outside air is introduced as cooling air CA from the intake port 352 into the controller housing 302a.

The cooling air CA passes through the controller housing 302a and flows into the motor housing 302b through the first and second openings 302c and 302d. At this time, the cooling air CA passes between the fins in the heat sink 351 to cool the heat sink 351.

Subsequently, the cooling air CA passes through the motor housing 302b and is exhausted from the motor housing 302b to the outside through the exhaust port 354. At this time, the cooling air CA passes through the vicinity of the motor 6 to cool the motor 6.

In this way, the outside air introduced into the housing 2 from the intake port 352 passes through the housing 2 (i.e., inside of the controller housing 302a and the motor housing 302b) as the cooling air CA and is exhausted through the exhaust port 354 to the outside of the housing 2. The cooling air CA cools the heat sink 351, the motor 6, and the like in the process of passing through the housing 2.

### 4-2. Relationship of Rotational Frequency, Output, Current, and Voltage to Torque

### <Characteristics on Motor Side>

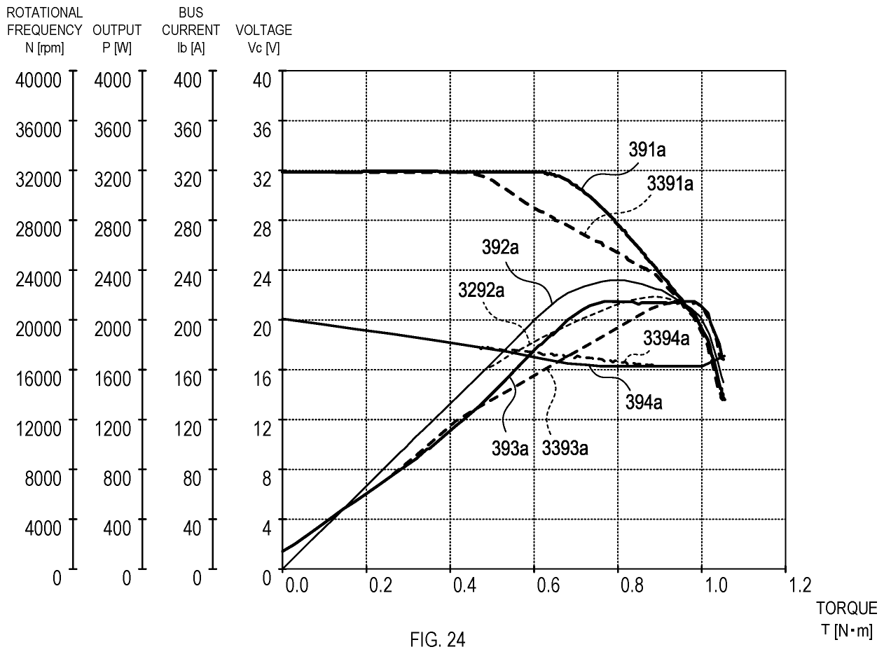

FIG. 24 shows actual N-T characteristics 391a and 3391a, actual P-T characteristics 392a and 3392a, actual I-T characteristics 393a and 3393a, and actual V-T characteristics 394a and 3394a in the motor 6 when the control in the third embodiment is performed on the motor 6.

The actual N-T characteristics 391a and 3391a each represent an example of measured values of the relationship between the rotational frequency N [rpm] and the torque T [N·m] of the motor 6.

The actual P-T characteristics 392a and 3392a each represent an example of measured values of the relationship between the motor output P [W], which is the output of the motor 6, and the torque T [N·m].

The actual I-T characteristics 393a and 3393a each represent an example of measured values of the relationship between the bus current value Ib [A] and the torque T [N·m].

The actual V-T characteristics 394a and 3394a each represent an example of measured values of the relationship between the power supply voltage Vc [V] and the torque T [N·m].

In FIG. 24, the actual N-T characteristic 391a, the actual P-T characteristic 392a, the actual I-T characteristic 393a, and the actual V-T characteristic 394a indicated by solid lines represent examples of measured values when the control circuit 30 has performed the field-weakening control. In FIG. 24, the actual N-T characteristic 3391a, the actual P-T characteristic 3392a, the actual I-T characteristic 3393a, and the actual V-T characteristic 3394a indicated by dashed lines represent examples of measured values when the control circuit 30 has not performed the field-weakening control.

As shown in FIG. 24, the control circuit 30 controls the motor 6 such that the maximum torque (i.e., the maximum value of the torque T) of the motor 6 is greater than or equal to 1.0 [N·m].

The control circuit 30 controls the motor 6 such that the maximum rotational frequency (i.e., the maximum value of the rotational frequency N) of the motor 6 is greater than or equal to 28000 [rpm]. Preferably, the control circuit 30 controls the motor 6 such that the maximum rotational frequency of the motor 6 is greater than or equal to 30000 [rpm].

The control circuit 30 controls the motor 6 such that the torque T is in the range of 0.3 [N·m] to 0.7 [N·m] and the maximum rotational frequency of the motor 6 is greater than or equal to 28000 [rpm]. Preferably, the control circuit 30 controls the motor 6 such that the torque T is in the range of 0.3 [N·m] to 0.7 [N·m] and the maximum rotational frequency of the motor 6 is greater than or equal to 30000 [rpm].

The control circuit 30 controls the motor 6 such that the bus current value Ib is in the range of 100 [A] to 200 [A], the torque T is in the range of 0.3 [N·m] to 0.7 [N·m], and the rotational frequency of the motor 6 is greater than or equal to 28000 [rpm]. Preferably, the control circuit 30 controls the motor 6 such that the bus current value Ib is in the range of 100 [A] to 200 [A], the torque T is in the range of 0.3 [N·m] to 0.7 [N·m], and the rotational frequency of the motor 6 is greater than or equal to 30000 [rpm].

The control circuit 30 may control the motor 6 such that the bus current value Ib is in the range of 100 [A] to 140 [A], the torque T is in the range of 0.3 [N·m] to 0.5 [N·m], and the rotational frequency of the motor 6 is greater than or equal to 30000 [rpm].

### <Characteristics on Blade Tool Side>

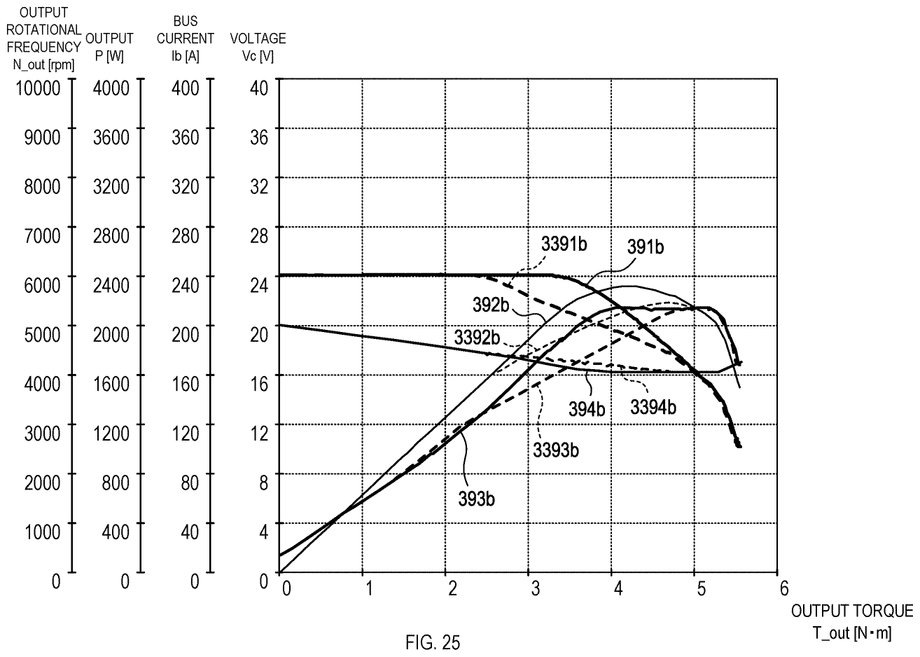

FIG. 25 shows actual N-T characteristics 391b and 3391b, actual P-T characteristics 392b and 3392b, actual I-T characteristics 393b and 3393b, and actual V-T characteristics 394b and 3394b on the side of the blade tool 309 driven by the motor 6 when the control in the third embodiment is performed on the motor 6.

The actual N-T characteristics 391b and 3391b each represent an example of measured values of the relationship between output rotational frequency N_out [rpm], output from the motor 6 to the blade tool 309, and output torque T_out [N·m], output from the motor 6 to the blade tool 309.

The actual P-T characteristics 392b and 3392b each represent an example of measured values of the relationship between the motor output P [W] and the output torque Tout [N·m].

The actual I-T characteristics 393b and 3393b each represent an example of measured values of the relationship between the bus current value Ib [A] and

the output torque T_out [N·m].

The actual V-T characteristics 394b and 3394b each represent an example of measured values of the relationship between the power supply voltage Vc [V] and the output torque Tout [N·m].

In FIG. 25, the actual N-T characteristic 391b, the actual P-T characteristic 392b, the actual I-T characteristic 393b, and the actual V-T characteristic 394b indicated by solid lines represent examples of measured values when the control circuit 30 has performed the field-weakening control. In FIG. 25, the actual N-T characteristic 3391b, the actual P-T characteristic 3392b, the actual I-T characteristic 3393b, and the actual V-T characteristic 3394b indicated by dashed lines represent examples of measured values when the control circuit 30 has not performed the field-weakening control.

As shown in FIG. 25, the control circuit 30 controls the motor 6 such that the maximum torque (i.e., the maximum value of the output torque Tout) of the motor 6 is greater than or equal to 5.5 [N·m].

The control circuit 30 controls the motor 6 such that the maximum output rotational frequency (i.e., the maximum value of the output rotational frequency N_out) of the motor 6 is greater than or equal to 5500 [rpm]. Preferably, the control circuit 30 controls the motor 6 such that the maximum output rotational frequency of the motor 6 is greater than or equal to 6000 [rpm].

The control circuit 30 controls the motor 6 such that the torque T is in the range of 2.0 [N·m] to 3.5 [N·m] and the maximum rotational frequency of the motor 6 is greater than or equal to 5500 [rpm]. Preferably, the control circuit 30 controls the motor 6 such that the torque T is in the range of 2.0 [N·m] to 3.5 [N·m] and the maximum rotational frequency of the motor 6 is greater than or equal to 6000 [rpm].

The control circuit 30 controls the motor 6 such that the bus current value Ib is in the range of 100 [A] to 200 [A], the torque T is in the range of 2.0 [N·m] to 3.5 [N·m], and the rotational frequency of the motor 6 is greater than or equal to 5500 [rpm]. Preferably, the control circuit 30 controls the motor 6 such that the bus current value Ib is in the range of 100 [A] to 200 [A], the torque T is in the range of 2.0 [N·m] to 3.5 [N·m], and the rotational frequency of the motor 6 is greater than or equal to 6000 [rpm].

The control circuit 30 may control the motor 6 such that the bus current value Ib is in the range of 100 [A] to 140 [A], the torque T is in the range of 1.8 [N·m] to 2.8 [N·m], and the rotational frequency of the motor 6 is greater than or equal to 6000 [rpm].

### 4-3. Effects

According to the third embodiment described above in detail, the same effects as those of (2a) to (2h) of the first embodiment can be obtained. In addition, according to the third embodiment, the following effects can be obtained.

(4a) The control circuit 30 controls the motor 6 by performing the field-weakening control. The electric work machine 301 is in the form of an electric circular saw.

According to such a configuration, it is possible to realize a circular saw that can output high torque T and can increase the rotational frequency N of the motor 6 when the torque T is low. In particular, as shown in FIG. 24 and FIG. 25, higher torque T or output torque T_out can be realized for the same rotational frequency N or output rotational frequency N_out compared with a case where the field-weakening control is not performed.

(4b) The drive transmission 307 includes the gear mechanism 307a.

Similarly to the first embodiment, the gear mechanism 307a reduces the rotational speed of the motor 6 transmitted to the blade tool 309 by the gear ratio of the two gears.

According to such a configuration, the torque T of the motor 6 is increased by reducing the rotational speed transmitted from the motor 6 to the blade tool 309 without largely fluctuating the current flowing through the motor 6. Therefore, the power consumption during work can be reduced while ensuring high torque T.

(4c) The intake port 352 of the controller housing 302a is provided to face the side surface of the blade case 308.

According to such a configuration, the blade case 308 can inhibit dust, dirt, and the like from flowing into the controller housing 302a from the intake port 352. Therefore, the dustproof property in the controller housing 302a can be improved.

(4d) The exhaust port 354 of the motor housing 302b is provided to face the side surface of the blade case 308.

According to such a configuration, the blade case 308 can inhibit dust, dirt, and the like from flowing into the motor housing 302b from the exhaust port 354. Therefore, the dustproof property in the motor housing 302b can be improved.

(4e) The electric work machine 301 includes the cooling fan 353. The cooling fan 353 introduces outside air as the cooling air CA into the controller housing 302a from the intake port 352. The cooling air CA cools the heat sink 351 in the controller housing 302a. The heat sink 351 is provided in the case 313a in which the controller 313 is housed.

According to such a configuration, by cooling the heat sink 351 with the cooling air CA, it is possible to cool the case 313a and the controller 313 together with the heat sink 351. Therefore, the heat dissipation efficiency of the controller 313 can be improved.

Furthermore, the cooling air CA passes through the controller housing 302a and flows into the motor housing 302b through the first and second openings 302c and 302d. The cooling air CA passes through the motor housing 302b and is exhausted from the motor housing 302b to the outside through the exhaust port 354. At this time, the cooling air CA passes through the vicinity of the motor 6.

According to such a configuration, the motor 6 can be cooled by the cooling air CA. Therefore, the heat dissipation efficiency of the motor 6 can be improved.

### 5. Other Embodiments

Embodiments of the present disclosure have been described above, but it goes without saying that the present disclosure is not limited to the above-described embodiments and can take various forms.

(5a) In the above embodiment, the control circuit 30 repeats the interruption process shown in FIG. 5 at regular intervals. The interruption process is executed in order from S10 to S80. However, the order of the interruption process is not limited thereto. For example, the processes in S10, 520, and S30 may be executed in any order, or some or all of them may be executed in parallel.

(5b) In the above-described embodiment, since slope m is set to zero, the path Pcd in the current trajectory 60 of the d-q coordinate system is a line segment parallel to the q-axis, as shown in FIG. 12. However, the slope m may be a value other than zero.

### (Example 1) when Slope m is Greater than Zero

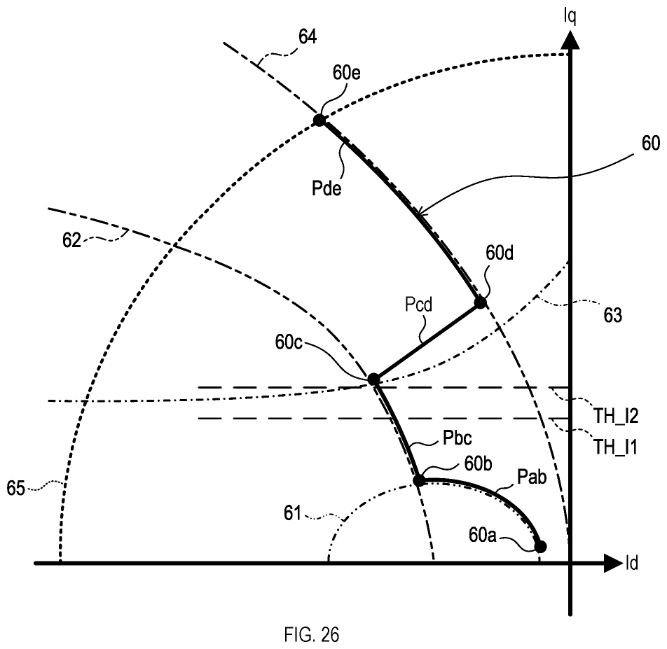

As shown in FIG. 26, the path Pcd is a trajectory in which the d-axis current Id increases as the q-axis current Iq increases in a region on a positive side of the q-axis with respect to the constant torque curve 63.

### (Example 2) when Slope m is Less than Zero

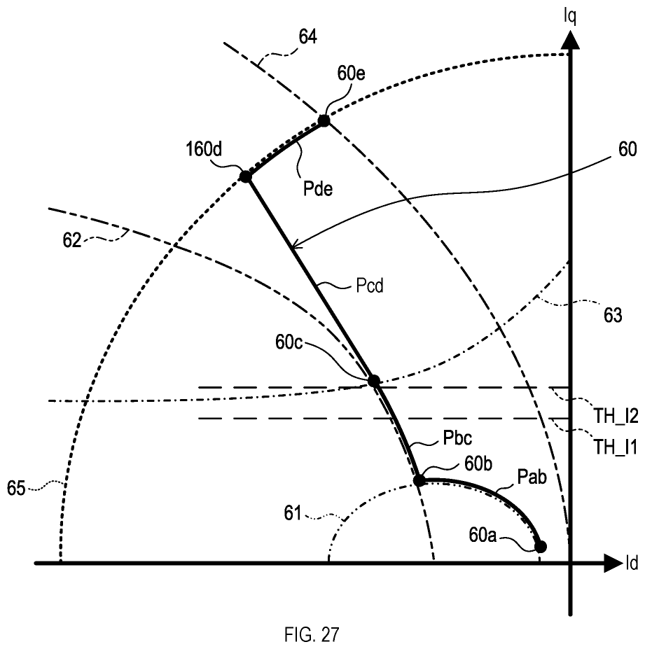

As shown in FIG. 27, the path Pcd is a trajectory in which the d-axis current Id decreases as the q-axis current Iq increases in a region on a positive side of the q-axis with respect to both the constant torque curve 63 and the MTPF curve 62.

At this time, the path Pcd can be a path from the intersection 60c to an intersection 160d. The intersection 160d is an intersection of the current limit circle 65 and a straight line passing through the intersection 60c. Furthermore, the path Pde can be a path from the intersection 160d to the intersection 60e. The current vector I is controlled so as to transition along the current limit circle 65 in the path Pde from the intersection 160d to the intersection 60e.

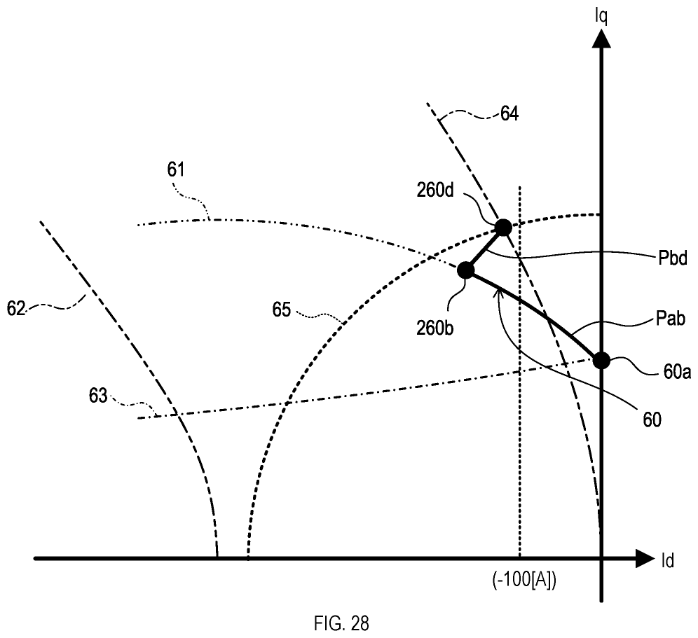

Alternatively, as shown in FIG. 28, the current vector I may be controlled so as to transition from the path Pab along a path Pbd without passing through the path Pcd. The path Pbd is a path from an intersection 260b to an intersection 260d. The intersection 260d is an intersection of the MTPA curve 64 and the current limit circle 65. The intersection 260b is an intersection of the back-EMF limit ellipse 61 and a straight line passing through the intersection 260d. The intersection 260b is located in a region on a positive side of the d-axis with respect to current limit circle 65.

At this time, the d-axis current Id in the path Pbd may be controlled to be a value less than or equal to −100 [A]. In other words, the magnitude (i.e., absolute value) of the d-axis current Id in the path Pbd may be controlled to be a value greater than or equal to 100 [A].

(5c) In the above embodiment, the current vector I transitions so as to linearly increase according to the slope m in the path Pcd from the intersection 60c to the intersection 60d. However, the current vector I is not limited to linearly increasing in the path Pcd and may transition so as to increase in the region on the positive side of the q-axis with respect to both the constant torque curve 63 and the MTPF curve 62.

(5d) In the above embodiment, in S410, the control circuit 30 sets the d-axis current command value Id_r to the d-axis current reference command value Id_hold+(the slope m×(the q-axis current measured value Iq_m−the q-axis current reference measured value Iq_hold)). However, the d-axis current command value Id_r in S410 is not limited to this value. The control circuit 30 may set the d-axis current command value Id_r based on the q-axis current command value Iq_r and the d-axis current command value Id_r such that the magnitude of the current vector I increases in the region on the positive side of the q-axis with respect to both the constant torque curve 63 and the MTPF curve 62.

(5e) In the above embodiments, the front handle 4 may be made of resin. The rear handle 5 may be made of resin. The guide bar 8 may be made of resin.

(5f) In the above embodiments, the battery 15a housed in the battery pack 15 may have cells having a tabless structure. The rated voltage of the battery 15a may be, for example, 18 [V] or 36 [V].

According to such a configuration, heat generation in the battery 15a can be reduced by the tabless structure.

(5g) In the above embodiments, the wire diameters of the power line Lp and the ground line Ln may each be greater than or equal to 2.5 [mm]. The wire diameters of the first to third lead wires 26 to 28 may each be greater than or equal to 2.5 [mm].

According to such a configuration, the resistance values of the power line Lp and the ground line Ln and the first to third lead wires 26 to 28 are smaller than a case where the wire diameters are less than 2.5 [mm]. Therefore, it is possible to reduce heat generation when a current flows through the power line Lp and the ground line Ln and the first to third lead wires 26 to 28.

The power line Lp and the ground line Ln and the first to third lead wires 26 to 28 correspond to examples of lead wires for a power supply and lead wires for a motor.

(5h) In the above embodiments, the control circuit 30 may preferably control the motor 6 such that the voltage phase of the voltage applied to the motor 6 is greater than or equal to 60 degrees and less than or equal to 90 degrees.

(5i) In the above embodiments, the control circuit 30 performs the field-weakening control by using the field-weakening control unit 45. However, the field-weakening control performed by the control circuit 30 is not limited to being performed by the process of the field-weakening control unit 45. That is, the control circuit 30 may perform the field-weakening control by other methods in addition to or instead of using the field-weakening control unit 45.

(5j) In the above embodiments, the control circuit 30 controls the motor 6 by performing the field-weakening control. At this time, the motor 6 mounted on the chainsaw as the electric work machine 1 can exhibit characteristics as shown in FIG. 17 or FIG. 18. The motor 6 mounted on the circular saw as the electric work machine 301 can exhibit characteristics as shown in FIG. 24 or FIG. 25.

However, the control circuit 30 may control the motor 6 such that the motor 6 exhibits characteristics as shown in FIG. 17 or FIG. 18, or FIG. 24 or FIG. 25 without performing the field-weakening control.

For example, the control circuit 30 may control the motor 6 mounted on the chainsaw such that the maximum torque of the motor 6 is greater than or equal to 4.0 [N·m] and the chain speed [m/s] during driving of the saw chain 9 is greater than or equal to 20 [m/s] or greater than or equal to 24 [m/s].

Alternatively, the control circuit 30 may control the motor 6 mounted on the circular saw such that the torque T is 0.3 [N·m] to 0.7 [N·m] and the rotational frequency of the motor 6 is greater than or equal to 28000 [rpm] or greater than or equal to 30000 [rpm] when the bus current value Ib is in the range of 100 [A] to 200 [A].

(5k) Two or more functions achieved by one element in the aforementioned embodiments may be achieved by two or more elements, and one function achieved by one element may be achieved by two or more elements. Two or more functions achieved by two or more elements may be achieved by one element, and one function achieved by two or more elements may be achieved by one element. A part of the configurations in the aforementioned embodiments may be omitted. At least a part of the configurations of the aforementioned embodiments may be added to or replaced with another part of the configurations of the aforementioned embodiments.

(5l) The present disclosure can be realized in various forms in addition to the control circuit 30 described above. For example, it can be realized in forms such as a system including the control circuit 30 as an element, a computer program for making a computer function as the control circuit 30, a non-transitory substantive recording medium such as a semiconductor memory in which this computer program is recorded, and a control method.

### 6. Other Aspects

### 6-1. Problems to be Solved by Other Aspects

In a chainsaw or circular saw equipped with a motor capable of outputting high torque, the rotational frequency of the motor tends to decrease when the torque output by the motor is low.

Preferably, one aspect of the present disclosure can increase the rotational frequency of the motor when the torque output by the motor is low in a chainsaw or a circular saw equipped with a motor capable of outputting high torque.

### 6-2. Technical Ideas of Other Aspects

In the above description, the present disclosure provides the technical ideas of the following other aspects.
1. A chainsaw comprising:
a motor including a stator and a rotor and configured to rotate the rotor by receiving electric power from a power supply;
a control circuit configured to control the motor by performing field-oriented control and field-weakening control; and
a drive transmission configured to drive a saw chain by transmitting the rotation of the rotor to the saw chain,
the drive transmission including a gear mechanism that reduces the rotational speed transmitted to the saw chain; and,
the control circuit being configured to control the motor such that the maximum torque of the motor is greater than or equal to 4.0 [N·m] and the speed of the saw chain is greater than or equal to 20 [m/s].
2. The chainsaw according to Aspect 1,
wherein the control circuit configured to control the motor such that maximum rotational frequency of the motor is greater than or equal to 10000 [rpm].
3. The chainsaw according to Aspect 1 or Aspect 2,
wherein a gear ratio in the gear mechanism is within a range from 1/3.73 to 1/1.60.
4. The chainsaw according to any one of Aspect 1 to Aspect 3,
wherein a diameter of the motor is greater than or equal to 40 [mm] and less than or equal to 80 [mm]; and
wherein a stack length of the stator is greater than or equal to 12 [mm] and less than or equal to 40 [mm].
5. The chainsaw according to any one of Aspect 1 to Aspect 4, wherein mass of a main body of the chainsaw is greater than or equal to 2.5 [kg] and less than or equal to 5.0 [kg].
6. The chainsaw according to Aspect 1 or Aspect 2,
wherein a gear ratio in the gear mechanism is within a range from 1/4.00 to 1/1.80.
7. The chainsaw according to Aspect 1, Aspect 2, or Aspect 6,
wherein a diameter of the motor is greater than or equal to 50 [mm] and less than or equal to 120 [mm]; and
wherein a stack length of the stator is greater than or equal to 10 [mm] and less than or equal to 50 [mm].
8. The chainsaw according to Aspect 1, Aspect 2, Aspect 6, or Aspect 7,
wherein mass of a main body of the chainsaw is greater than or equal to 5.0 [kg] and less than or equal to 7.0 [kg].
9. The chainsaw according to any one of Aspect 1 to Aspect 8,
wherein the motor is an inner-rotor type brushless DC motor.
10. The chainsaw according to any one of Aspect 1 to Aspect 9, further comprising:
a guide bar to which the saw chain is attached; and
a handle for a user to grip;
wherein at least one of the guide bar or the handle is made of resin.
11. The chainsaw according to any one of Aspect 1 to Aspect 10,
wherein rated voltage of the power supply is 36 [V].
12. A circular saw comprising:
a motor including a stator and a rotor and configured to rotate the rotor by receiving electric power from a power supply;
a housing that houses the motor;
a control circuit configured to control the motor by performing field-weakening control;
a drive transmission configured to drive a blade tool by transmitting rotation of the rotor to the blade tool;
a blade case that covers the blade tool; and
a battery attachment part to which a battery pack as the power supply can be attached;
rated voltage of the power supply being 18 [V].
13. A circular saw comprising:
a motor including a stator and a rotor and configured to rotate the rotor by receiving electric power from a power supply;
a housing that houses the motor;
a control circuit configured to control the motor by performing field-weakening control;
a drive transmission configured to drive a blade tool by transmitting rotation of the rotor to the blade tool;
a blade case that covers the blade tool; and
a battery attachment part to which a battery pack as the power supply can be attached;
wherein the control circuit configured to control the motor such that (i) torque output by the motor is greater than or equal to 0.3 [N·m] and less than or equal to 0.7 [N·m] and (ii) the rotational frequency of the motor is greater than or equal to 30000 [rpm] and less than or equal to 32000 [rpm] in association with magnitude of a bus current supplied from the power supply to the motor being greater than or equal to 100 [A] and less than or equal to 200 [A].
14. The circular saw according to Aspect 13,
wherein rated voltage of the power supply is 18 [V].
15. The circular saw according to any one of Aspect 12 to Aspect 14,
wherein the control circuit configured to control the motor such that voltage phase of voltage applied to the motor is greater than or equal to 60 degrees and less than or equal to 90 degrees.
16. The circular saw according to any one of Aspect 12 to Aspect 15,
the control circuit configured to control the motor such that magnitude of a d-axis current in the field-weakening control is greater than or equal to 100 [A].
17. The circular saw according to any one of Aspect 12 to Aspect 16,
wherein the control circuit is electrically coupled to the power supply via a lead wire for power supply and is electrically coupled to the motor via a lead wire for a motor; and
wherein wire diameters of the lead wire for power supply and the lead wire for the motor are both greater than or equal to 2.5 [mm].
18. The circular saw according to any one of Aspect 12 to Aspect 17,
wherein a heat sink is provided in the control circuit.
19. The circular saw according to any one of Aspect 12 to Aspect 18, further comprising:
an intake port provided in the housing to face a side surface of the blade case.
20. The circular saw according to Aspect 19, further comprising:
a cooling fan provided in the housing and rotated by the motor,
wherein the cooling fan is configured to introduce cooling air for cooling the control circuit into the housing from the intake port.
21. The circular saw according to any one of Aspect 12 to Aspect 20,
wherein the battery pack houses a battery; and
wherein the battery includes cells having a tabless structure.

What is claimed is:

1. An electric work machine comprising:
a motor including a stator and a rotor and configured to be driven by receiving electric power from a power supply; and
a control circuit;
the stator being configured to generate a magnetic field by a current flowing therethrough;
the rotor including a magnetic material and configured to rotate about a rotational axis in response to a change in the magnetic field;
the current including a d-axis component, which is a component of a d-axis, and a q-axis component, which is a component of a q-axis, in a d-q coordinate system having the d-axis and the q-axis orthogonal to each other;
the control circuit being configured (i) to control the motor so as to cause the current corresponding to a current command value to flow through the stator and (ii) to set the current command value in a region on a positive side of the q-axis relative to both a given constant torque curve and a maximum flux efficiency curve in association with a measured value of the q-axis component being included in a region on a positive side of the q-axis relative to an intersection of the given constant torque curve and the maximum flux efficiency curve; and
the maximum flux efficiency curve being a set of points where a maximum torque per unit magnetic flux is obtained in the d-q coordinate system.

2. The electric work machine according to claim 1,
wherein the control circuit is configured to set the current command value in the region on the positive side of the q-axis relative to both the given constant torque curve and the maximum flux efficiency curve and in a region on a negative side of the q-axis relative to a maximum current efficiency curve in association with the measured value of the q-axis component being included in a region on a positive side of the q-axis relative to the intersection; and
wherein the maximum current efficiency curve is a set of points where a maximum torque per unit current is obtained in the d-q coordinate system.

3. An electric work machine comprising:
a motor including a stator and a rotor and configured to be driven by receiving electric power from a power supply; and
a control circuit;
the stator being configured to generate a magnetic field by a current flowing therethrough;
the rotor including a magnetic material and configured to rotate about a rotational axis in response to a change in the magnetic field; and
the control circuit being configured (i) to transition between two or more modes including a first mode, a second mode, and a third mode, to operate in one mode of the two or more modes, and to control the motor so as to cause the current corresponding to a current command value to flow through the stator, (ii) to set the current command value in the first mode so as to maximize torque per unit current, (iii) to set the current command value in the second mode so as to generate the magnetic field in a direction that reduces magnetic flux generated from the magnetic material, (iv) to operate so as to pass through the third mode in association with transitioning from the second mode to the first mode, (v) to store a measured value of the current that was flowing through the stator and the current command value to be flowed through the stator as a reference measured value and a reference command value, respectively, in association with the control circuit transitioning from the second mode to the third mode, and (vi) to set the current command value in the third mode based on at least one of the reference measured value or the reference command value.

4. The electric work machine according to claim 3,
wherein the control circuit is configured to set the current command value in the third mode based on both a difference between the reference measured value and the measured value of the current, and the reference command value.

5. The electric work machine according to claim 3,
wherein, in a d-q coordinate system having the d-axis and the q-axis orthogonal to each other, the current includes a d-axis component that is a component of the d-axis and a q-axis component that is a component of the q-axis; and
wherein the control circuit is configured to transition from the second mode to the third mode in response to a measured value of the q-axis component being greater than or equal to a given threshold value.

6. The electric work machine according to claim 5,
wherein the control circuit is configured to set the current command value in the third mode in a region on a positive side of the q-axis relative to the given constant torque curve in the d-q coordinate system.

7. The electric work machine according to claim 5,
wherein the control circuit is configured to transition between two or more modes based on the measured value of the q-axis component.

8. The electric work machine according to claim 1,
wherein the control circuit is configured to perform constant rotation control,
based on the d-axis component in the current command value, for maintaining rotational frequency of the motor constant.

9. The electric work machine according to claim 8,
wherein the constant rotation control includes a process of decreasing the d-axis component in the current command value.

10. The electric work machine according to claim 9,
wherein the constant rotation control includes a process of decreasing the d-axis component in the current command value such that a command value of the current is set within a region of a back-EMF limit ellipse in the d-q coordinate system.

11. The electric work machine according to claim 1,
wherein the control circuit is configured (i) to obtain a measured value of a power supply current supplied from the power supply and an upper limit value of the power supply current, and (ii) to calculate an upper limit value of the d-axis component of the current command value based on the measured value of the power supply current and the upper limit value of the power supply current.

12. The electric work machine according to claim 11,
wherein the control circuit is configured to calculate the upper limit value of the d-axis component of the current command value by multiplying a measured value of the d-axis component by a value obtained by adding 1 (one) to a difference between the measured value of the power supply current and the upper limit value of the power supply current.

13. An electric work machine comprising:
a motor including a stator and a rotor and configured to be driven by receiving electric power from a power supply; and
a control circuit;
the stator being configured to generate a magnetic field by a current flowing therethrough;
the rotor including a magnetic material and configured to rotate about a rotational axis in response to a change in the magnetic field; and
the control circuit being configured (i) to transition between two or more modes including a first mode, a second mode, and a third mode, to operate in one mode of the two or more modes, and to control the motor so as to cause the current corresponding to a current command value to flow through the stator, (ii) to set the current command value in the first mode so as to maximize torque per unit current, (iii) to set the current command value in the second mode so as to generate the magnetic field in a direction that reduces magnetic flux generated from the magnetic material, (iv) to operate so as to pass through the third mode in association with transitioning from the second mode to the first mode, and (v) to set the current command value in the third mode such that torque of the motor increases as rotational frequency of the motor decreases.

14. A control method for controlling a motor including a stator and a rotor, the method comprising:
controlling the motor so as to cause a current corresponding to a current command value to flow through the stator; and
setting the current command value in a region on a positive side of a q-axis relative to both a given constant torque curve and a maximum flux efficiency curve in a d-q coordinate system having a d-axis and the q-axis orthogonal to each other in association with a measured value of a q-axis component, which is a component of the q-axis of the current, being included in a region on a positive side of the q-axis relative to an intersection of the given constant torque curve and a maximum flux efficiency curve,
the maximum flux efficiency curve being a set of points where maximum torque per unit magnetic flux is obtained in the d-q coordinate system.

15. A control method for controlling a motor including a stator and a rotor, the method comprising:
controlling the motor so as to cause a current corresponding to a current command value to flow through the stator;
transitioning between two or more modes including a first mode, a second mode, and a third mode, and operating in one mode of the two or more modes to control the motor so as to cause the current corresponding to the current command value to flow through the stator;
setting the current command value in the first mode so as to maximize torque per unit current;
setting the current command value in the second mode so as to generate a magnetic field in a direction that reduces magnetic flux generated from a magnetic material of the rotor;
operating so as to pass through the third mode in association with transitioning from the second mode to the first mode;
storing a measured value of the current that was flowing through the stator and the current command value to be flowed through the stator as a reference measured value and a reference command value, respectively, in association with transitioning from the second mode to the third mode; and
setting the current command value in the third mode based on at least one of the reference measured value or the reference command value.
